(19) United States
(12) Patent Application Publication
(10) Pub. No.: US 2023/0322640 A1
(43) Pub. Date: Oct. 12, 2023

(54) Process for Treating Livestock Waste to Produce Fertilizers

(71) Applicant: Fertilisation Fertiroy Inc., Gatineau (CA)

(72) Inventors: Luc Roy, Gatineau (CA); Stéphane Godbout, Gatineau (CA); Patrick Brassard, Gatineau (CA)

(21) Appl. No.: 18/042,016

(22) PCT Filed: Aug. 20, 2021
(86) PCT No.: PCT/CA2021/051158

§ 371 Date: Feb. 17, 2023

Related U.S. Application Data
(60) Provisional application No. 63/068,568, filed on Aug. 21, 2020.

(51) Int. Cl. C05F 3/06

(52) U.S. Cl. CPC C05F 3/06

(57) ABSTRACT

These is provided a process and a system for treating a livestock waste and produce fertilizers. The process can include subjecting a livestock waste to a preparation treatment to produce a stabilized livestock waste, the preparation treatment including aerating the livestock waste with an oxygen-containing gas. The process can further include subjecting the stabilized livestock waste to a bioreaction treatment to produce an aerated livestock product. The bioreaction treatment can include aerating the stabilized livestock waste with an oxygen-containing gas that can be supplied by a distribution system to enable aerobic reactions to occur within the stabilized livestock waste. The aerated livestock product can include a solid component and a liquid component, and can be further separated in a solid-liquid separation treatment to produce respective fertilizers, or be used as is as a fertilizer.

### TECHNICAL FIELD

The technical field generally relates to processes and methods for treating livestock waste. More particularly, the technical field relates to processes and methods for aerating waste, such as swine manure, to produce fertilizers.

### BACKGROUND

The treatment of livestock waste has various technical and economic challenges that arise from the composition and properties of the waste. Nevertheless, livestock waste remains a potential source of compounds that can be reused in various industries. There is a need for technologies that respond to at least some of the challenges to treat and valorize livestock waste.

### SUMMARY

In accordance with an aspect, there is provided a process for treating a livestock waste, comprising:
subjecting the livestock waste to a preparation treatment, comprising:
   supplying the livestock waste to a preparation reservoir in fluid communication with a first oxygen-containing gas distribution system; and
   aerating the livestock waste with a first oxygen-containing gas from the first oxygen-containing gas distribution system to produce a stabilized livestock waste; and
subjecting the stabilized livestock waste to a bioreaction treatment, comprising:
   supplying the stabilized livestock waste to a bioreactor in fluid communication with the preparation reservoir and with a second oxygen-containing gas distribution system, the bioreactor comprising a pipeline configured for receiving and circulating the stabilized livestock waste therewithin; and
   aerating the stabilized livestock waste with a second oxygen-containing gas from the second oxygen-containing gas distribution system to enable aerobic reactions to occur within the stabilized livestock waste and produce an aerated livestock product having a solid component and a liquid component, the second oxygen-containing gas distribution system comprising a conduit extending within the pipeline and comprising a plurality of openings to introduce the second oxygen-containing gas within the pipeline.

In some implementations, the pipeline comprises at least one portion that extends substantially longitudinally.

In some implementations, the pipeline comprises a plurality of pipelines.

In some implementations, at least two pipelines of the plurality of pipelines are provided in a superposed relationship relative to each other.

In some implementations, at least two pipelines of the plurality of pipelines is provided in a side-by-side relationship relative to each other.

In some implementations, the plurality of pipelines forms a network of interconnected pipelines in fluid communication with one another.

In some implementations, at least one of the plurality of pipelines comprises a portion that extends substantially longitudinally.

In some implementations, the aerated livestock product is suitable for use as a fertilizer.

In some implementations, the process further comprises subjecting the aerated livestock product to a solid-liquid separation to obtain a solid-enriched phase comprising predominantly the solid component and a solid-depleted phase comprising predominantly the liquid component.

In some implementations, subjecting the aerated livestock product to the solid-liquid separation comprises settling the aerated livestock in a settling reservoir.

In some implementations, the process further comprises retrieving a portion of the solid-enriched phase from the settling reservoir to obtain a solid-enriched stream.

In some implementations, the process further comprises retrieving a portion of the solid-depleted phase from the settling reservoir to obtain a solid-depleted stream.

In some implementations, subjecting the aerated livestock product to the solid-liquid separation comprises supplying the aerated livestock product to at least one of a decanter, a gravity settler, and a thickener.

In some implementations, subjecting the aerated livestock product to the solid-liquid separation comprises supplying the aerated livestock product to a decanter centrifuge.

In some implementations, the solid-enriched phase is usable as a substantially solid fertilizer comprising phosphorus.

In some implementations, the solid-enriched phase is subjected to a further treatment to obtain a substantially solid fertilizer.

In some implementations, the solid-depleted phase is usable as a substantially liquid fertilizer comprising nitrogen.

In some implementations, the solid-depleted phase is subjected to a further treatment to obtain a substantially liquid fertilizer.

In some implementations, the preparation treatment further comprises mixing the livestock waste at least during the aerating of the livestock waste.

In some implementations, the preparation treatment further comprises mixing the livestock waste prior the aerating of the livestock waste.

In some implementations, mixing the livestock waste comprises homogenizing the livestock waste.

In some implementations, the preparation treatment further comprises recirculating the livestock waste via a recirculation loop.

In some implementations, recirculating the livestock waste comprises controlling a recirculation flow rate of the livestock waste via the recirculation loop.

In some implementations, aerating the livestock waste comprises passing the livestock waste through a Venturi device.

In some implementations, aerating the livestock waste is performed to avoid coalescence of bubbles of the first oxygen-containing gas.

In some implementations, aerating the stabilized livestock waste comprises producing fine bubbles within the stabilized livestock waste.

In some implementations, aerating the stabilized livestock waste is performed to reduce an organic matter content thereof.

In some implementations, the process further comprises controlling an operating parameter of the preparation treatment to achieve a given property of the stabilized livestock waste.

In some implementations, the operating parameter comprises at least one of a temperature of the livestock waste within the preparation reservoir, a residence time of the livestock waste within the preparation reservoir, and a flow rate of the first oxygen-containing gas.

In some implementations, the temperature of the livestock waste during the preparation treatment is between 5° C. and 45° C.

In some implementations, the temperature of the livestock waste during the preparation treatment is between 15° C. and 45° C.

In some implementations, the temperature of the livestock waste during the preparation treatment is above 45° C.

In some implementations, the residence time of the livestock waste in the preparation reservoir is at least 10 days.

In some implementations, the residence time of the livestock waste in the preparation reservoir is between 4 days and 30 days.

In some implementations, the flow rate of the first oxygen-containing gas during the preparation treatment is between 5 L O₂/min·m³ and 40 L O₂/min·m³.

In some implementations, the flow rate of the first oxygen-containing gas during the preparation treatment is between 5 L O₂/min·m³ and 25 L O₂/min·m³.

In some implementations, the flow rate of the first oxygen-containing gas during the preparation treatment is between 0.2 L O₂/min·m³ and 2 L O₂/min·m³.

In some implementations, the given property of the stabilized livestock waste comprises at least one of dissolved organic carbon (DOC), Total solids, Total suspended solids (TSS), Total dissolved solids (TDS), Total volatile solids (TVS), Volatile suspended solids (VSS), a biochemical oxygen demand (BOD), a chemical oxygen demand (COD), a pH of the livestock waste a composition of the livestock waste, and a concentration of oxygen in the stabilized livestock waste.

In some implementations, the dissolved organic carbon of the stabilized livestock waste is between 20 000 mg/kg and 5 000 mg/kg.

In some implementations, the dissolved organic carbon of the stabilized livestock waste is between 15 000 mg/kg and 3 000 mg/kg.

In some implementations, the total solids of the stabilized livestock is between 65 g/L and 160 g/L.

In some implementations, the total suspended solids of the stabilized livestock are between 55 g/L and 130 g/L.

In some implementations, the total dissolved solids of the stabilized livestock are between 12 g/L and 25 g/L.

In some implementations, the total volatile solids of the stabilized livestock are between 90 g/L and 130 g/L.

In some implementations, the volatile suspended solids of the stabilized livestock are between 3 g/L and 120 g/L.

In some implementations, the pH of the livestock waste is between 5 and 9.

In some implementations, the pH of the livestock waste is between 6 and 8.

In some implementations, the pH of the livestock waste is between 7 and 8.5.

In some implementations, the concentration of oxygen in the stabilized livestock waste is below 1%.

In some implementations, the concentration of oxygen in the stabilized livestock waste is between 1% and 15%.

In some implementations, the concentration of oxygen in the stabilized livestock waste is above 15%.

In some implementations, the solid-enriched phase of the aerated livestock product represents approximately 50% v/v of the aerated livestock product.

In some implementations, the solid-enriched phase of the aerated livestock product represents approximately 30% v/v of the aerated livestock product, and the solid-depleted phase represents approximately 70% v/v of the aerated livestock product.

In some implementations, at least one of the first oxygen-containing gas and the second oxygen-containing gas comprises air.

In accordance with another aspect, there is provided a process for treating a livestock waste comprising solids and liquid, the process comprising:
subjecting the stabilized livestock waste to a bioreaction treatment, comprising:
   supplying the stabilized livestock waste to a bioreactor comprising a pipeline configured for receiving and circulating the stabilized livestock waste therewithin, the bioreactor being in fluid communication with an oxygen-containing gas distribution system configured for introducing an oxygen-containing gas into the stabilized livestock waste; and
   aerating the stabilized livestock waste with the oxygen-containing gas from the oxygen-containing gas distribution system to enable aerobic reactions to occur within the stabilized livestock waste and produce an aerated livestock product having a solid component and a liquid component, the oxygen-containing gas distribution system extending within the pipeline and comprising a plurality of openings to introduce the oxygen-containing gas within the pipeline.

In some implementations, the pipeline comprises at least one portion that extends substantially longitudinally.

In some implementations, the pipeline comprises a plurality of pipelines.

In some implementations, at least two pipelines of the plurality of pipelines are provided in a superposed relationship relative to each other.

In some implementations, at least two pipelines of the plurality of pipelines is provided in a side-by-side relationship relative to each other.

In some implementations, the plurality of pipelines forms a network of interconnected pipelines in fluid communication with one another.

In some implementations, at least one of the plurality of pipelines comprises a portion that extends substantially longitudinally.

In some implementations, the aerated livestock product is suitable for use as a fertilizer.

In some implementations, the process further comprises subjecting the aerated livestock product to a solid-liquid separation to obtain a solid-enriched phase comprising predominantly the solid component and a solid-depleted phase comprising predominantly the liquid component.

In some implementations, subjecting the aerated livestock product to the solid-liquid separation comprises settling the aerated livestock in a settling reservoir.

In some implementations, the process further comprises retrieving a portion of the solid-enriched phase from the settling reservoir to obtain a solid-enriched stream.

In some implementations, the process further comprises retrieving a portion of the solid-depleted phase from the settling reservoir to obtain a solid-depleted stream.

In some implementations, subjecting the aerated livestock product to the solid-liquid separation comprises supplying the aerated livestock product to at least one of a decanter, a gravity settler, and a thickener.

In some implementations, subjecting the aerated livestock product to the solid-liquid separation comprises supplying the aerated livestock product to a decanter centrifuge.

In some implementations, the solid-enriched phase is usable as a solid fertilizer comprising phosphorus.

In some implementations, the solid-depleted phase is usable as a liquid fertilizer comprising nitrogen.

In some implementations, the aerating is performed intermittently.

In some implementations, the aerating is performed continuously.

In some implementations, the process further comprising one or more features as defined herein.

In accordance with another aspect, a system for treating a livestock waste, comprising:
a preparation unit comprising:
   a preparation reservoir configured to receive the livestock waste; and
   a first oxygen-containing gas distribution system in fluid communication with the preparation reservoir to supply a first oxygen-containing gas to the livestock waste and produce a stabilized livestock waste;
a bioreactor unit comprising:
   a bioreactor in fluid communication with the preparation reservoir, the bioreactor comprising:
      a pipeline configured for receiving and circulating the stabilized livestock waste therewithin from one location to another; and
      a second oxygen-containing gas distribution system in fluid communication with the pipeline to supply a second oxygen-containing gas to the stabilized livestock and produce an aerated livestock product having a solid component and a liquid component, the second oxygen-containing gas distribution system comprising a conduit extending within the pipeline and comprising a plurality of openings to introduce the second oxygen-containing gas within the pipeline and into the stabilized livestock waste.

In some implementations, the system further comprises a solid-separation unit configured to receive the aerated livestock product to obtain a solid-enriched phase comprising the solid component and a solid-depleted phase comprising the liquid component.

In some implementations, the pipeline comprises at least one portion that extends substantially longitudinally.

In some implementations, the pipeline comprises a plurality of pipelines.

In some implementations, at least two pipelines of the plurality of pipelines are provided in a superposed relationship relative to each other.

In some implementations, at least two pipelines of the plurality of pipelines is provided in a side-by-side relationship relative to each other.

In some implementations, the plurality of pipelines forms a network of interconnected pipelines in fluid communication with one another.

In some implementations, at least one of the plurality of pipelines comprises a portion that extends substantially longitudinally.

In some implementations, the bioreactor includes a main pipeline that divides into the plurality of pipelines.

In some implementations, the bioreactor includes a number of pipelines determined according to their respective length to achieve a resulting length of the bioreactor.

In some implementations, a configuration of the pipeline is determined in accordance with variations in a ground surface between the preparation reservoir and the solid-liquid separation unit.

In some implementations, the first oxygen-containing gas distribution system is configured to avoid coalescence of bubbles of the first oxygen-containing gas.

In some implementations, the first oxygen-containing gas distribution system is configured to provide fine bubbles into the stabilized livestock waste.

In some implementations, the first oxygen-containing gas comprises air.

In some implementations, the second oxygen-containing gas comprises air.

In some implementations, the bioreactor comprises a series of bioreactors provided in series.

In some implementations, the pipeline has a diameter of between 70 cm and 120 cm.

In some implementations, a length and/or a diameter of the pipeline is determined according to a volume of stabilized livestock waste to be treated.

In some implementations, the bioreactor is configured to providing a turbulent flow of the livestock waste circulating in the pipeline to enhance mixing of the livestock waste.

In some implementations, the conduit has a diameter of between 1 cm and 10 cm.

In some implementations, the conduit has a diameter between 0.1 cm and 3 cm.

In some implementations, the conduit comprises a plurality of conduits.

In some implementations, the plurality of openings includes a first series of openings having a first diameter in a first section of the bioreactor that is closer to the preparation reservoir, and a second series of openings having a second diameter in a second section of the bioreactor that is closer to the solid-liquid separation unit.

In some implementations, the plurality of openings includes a first series of openings provided at a first distance from one another in a first section of the bioreactor that is closer to the preparation reservoir, and a second series of openings provided at a second distance from one another in a second section of the bioreactor that is closer to the solid-liquid separation unit.

In some implementations, the plurality of openings comprises openings provided as an array extending longitudinally along a length of the conduit.

In some implementations, the plurality of openings comprises openings distributed randomly around an outer periphery of the conduit.

In some implementations, the plurality of openings comprises openings distributed according to a given pattern around an outer periphery of the conduit.

In some implementations, the second oxygen-containing gas distribution system is configured for introducing the second oxygen-containing gas into the stabilized livestock waste at a flow rate between 5 L O₂/min·m³ and 60 L O₂/min·m³.

In some implementations, the second oxygen-containing gas distribution system is configured for introducing the second oxygen-containing gas into the stabilized livestock waste at a flow rate between 10 L O₂/min·m³ and 50 L O₂/min·m³.

In some implementations, the second oxygen-containing gas distribution system is configured for introducing the second oxygen-containing gas into the stabilized livestock waste at a flow rate to achieve a given concentration of oxygen in the aerated livestock product.

In some implementations, the system comprises one or more features as defined in any above clause and/or as described and/or illustrated herein.

### BRIEF DESCRIPTION OF THE DRAWINGS

The attached figures illustrate various features, aspects and implementations of the technology described herein.

FIG. 1 is a block diagram of an example of a process for treating a livestock waste, the process including a preparation treatment, a bioreaction treatment, and a solid-liquid separation.

FIG. 2 is a schematic representation of a preparation reservoir, a bioreactor, and a reservoir for performing a solid-liquid separation, according with an implementation.

FIG. 3 is a schematic representation of a preparation reservoir, a bioreactor, and a reservoir for performing a solid-liquid separation, according to another implementation.

FIG. 4 is a schematic representation of a bioreactor for treating a stabilized livestock waste, the bioreactor including a main conduit that divides into a plurality of pipelines.

FIGS. 5-7 are schematic representations of various configurations of a plurality of pipelines of a bioreactor.

FIGS. 8-11 are schematic representations of various configurations of a conduit or a plurality of conduits extending within a pipeline of a bioreactor.

FIG. 12 is a schematic representation of a bioreactor that includes a pipeline and a conduit that extends within the cavity of the pipeline, the conduit including a plurality of openings provided as an array.

FIG. 13 is a schematic representation of a bioreactor that includes a pipeline and a conduit that extends within the cavity of the pipeline, the conduit including a plurality of openings provided as a spiral around the outer periphery of the conduit.

FIG. 14 is a schematic representation of a preparation reservoir, a bioreactor that includes a first section and a second section, and a reservoir for performing a solid-liquid separation, the first section of the conduit including a first series of openings and the second section of the conduit including a second series of openings.

FIG. 15 is a schematic representation of a preparation reservoir, a bioreactor that includes a first section and a second section, and a reservoir for performing a solid-liquid separation, the first section of the conduit including a first series of openings and the second section of the conduit including a second series of openings.

FIG. 16 is a schematic representation of a conduit that includes two series of openings being provided in a diametrically opposed configuration.

FIG. 17 is a cross-sectional view of the conduit of FIG. 16.

FIG. 18 is a graph showing the temperature as a function of time in days during an experimentation of a preparation treatment.

### DETAILED DESCRIPTION

Techniques described herein relate to processes, methods and systems for treating livestock waste, such as swine manure, and produce fertilizers therefrom for use for instance in agricultural applications.

The proposed techniques can include subjecting a livestock waste that comprises solids and liquid to a preparation treatment to produce a stabilized livestock waste. The preparation treatment can generally be aimed at homogenizing the livestock waste and activating the aerobic microbial flora contained therein. Such preparation treatment can be beneficial to achieve given properties of the stabilized livestock waste for subsequent treatment.

The stabilized livestock waste can then be subjected to a bioreaction treatment to produce an aerated livestock product that includes a solid-enriched component and a solid-depleted component. In some implementations, the stabilized livestock is provided as such to the bioreaction treatment, i.e., without subjecting the stabilized livestock to another treatment such as a solid-liquid separation. The bioreaction treatment can include supplying an oxygen-containing gas to the stabilized livestock waste. The bioreaction treatment can be performed in a bioreactor that can include one or more pipelines configured for receiving and conditioning the stabilized livestock waste. When more than one pipeline is present, the bioreactor can take the form of interconnected pipelines that are in fluid communication with one another. As mentioned above, the bioreactor is configured for aerating the stabilized livestock waste with an oxygen-containing gas to enable aerobic reactions to occur within the stabilized livestock waste. This can be achieved via a distribution system that extends within the one or more pipelines, and that comprises a plurality of openings to introduce the oxygen-containing gas into the one or more pipelines.

The bioreaction treatment can contribute to concentrating certain nutrients such as phosphorus and nitrogen in a given phase of the aerated livestock product. Accordingly, the bioreaction treatment can produce an aerated livestock product that includes a solid component that is enriched in phosphorus, and a liquid component that is enriched in nitrogen.

In some implementations, the aerated livestock product can be used directly as a fertilizer. In other implementations, the aerated livestock product can be further subjected to a solid-liquid separation, for instance in a settling reservoir or decanter, to enable formation of a solid-enriched phase that predominantly includes the solid component of the livestock product, and of a solid-depleted phase that predominantly includes the liquid component of the aerated livestock product. The solid-liquid separation can thus enable the production of a substantially solid fertilizer having a desired phosphorus content, and of a substantially liquid fertilizer having a desired nitrogen content, such that each one of the substantially solid fertilizer and the substantially liquid fertilizer can be used for respective agricultural applications.

Various implementations of the processes, methods and systems for treating livestock waste will now be described in greater detail.

### General Overview of the Process

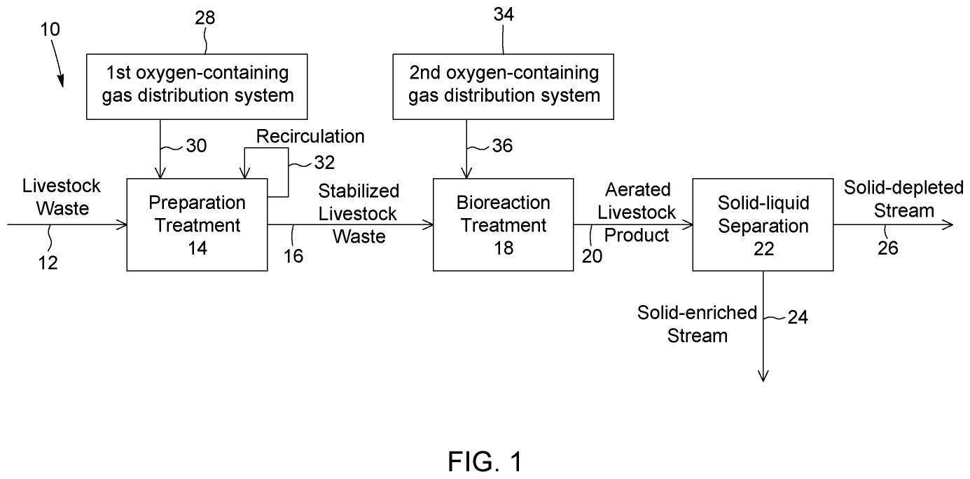

With reference to FIG. 1, an example of a process for treating a livestock waste 10 is shown. The process for treating a livestock waste 10 includes subjecting a livestock waste 12 to a preparation treatment 14 to produce a stabilized livestock waste 16. The stabilized livestock waste 16 is then subjected to a bioreaction treatment 18 to produce an aerated livestock product 20 that includes a solid component and a liquid component. The aerated livestock product 20 can be subjected to further treatment(s), or can be used directly as a fertilizer.

In the illustrated implementation, the aerated livestock product 20 is subsequently subjected to a solid-liquid separation 22 to enable separation of a solid-enriched phase and a solid-depleted phase. The solid-liquid separation can be performed for instance in a settling reservoir or a decanter, or any other suitable solid-liquid separation unit. A portion of the solid-enriched phase can be retrieved from the solid-liquid separation unit as a solid-enriched stream 24, and a portion of the solid-depleted phase can be retrieved from the solid-liquid separation unit as a solid-depleted stream 26. Once retrieved from the solid-liquid separation unit, each one of the solid-enriched stream 24 and the solid-depleted stream 26 can be subjected to further treatments to obtain corresponding fertilizers having certain characteristics, or they can be used directly as corresponding fertilizers.

Still referring to FIG. 1, the preparation treatment 14 can be performed in a preparation reservoir, the preparation reservoir being in fluid communication with a first oxygen-containing gas distribution system 28. The first oxygen-containing gas distribution system 28 enables supplying a first oxygen-containing gas 30 to the preparation reservoir. The first oxygen containing-gas 30 can be any suitable gas that includes oxygen so that aerobic reactions within the livestock waste 12 can occur. In some implementations, the first oxygen-containing gas 30 can be air. In some implementations, the first oxygen-containing gas distribution system 28 can include an oxygen-containing gas supply, for instance when the oxygen containing gas is different from air. In some implementations, the first oxygen-containing gas distribution system 28 can include a pump and a conduit to introduce the oxygen-containing gas 30 into the livestock waste 12. It is to be understood that when the first oxygen-containing gas 30 is air, the first oxygen-containing gas distribution system 28 does not necessarily include a reservoir holding a given volume of air. In other words, the first oxygen-containing gas distribution system 28 can include any system or device that is configured to introduce air into the livestock waste, such as a pipe having a constricted section, e.g., a Venturi device, or a pump.

In some implementations, the preparation reservoir can also include a recirculation loop 32 to facilitate homogenization of the livestock waste 12. More details regarding this aspect are provided below.

The bioreaction treatment 18 can be performed using a bioreactor comprising one or more pipelines. As mentioned above, when the bioreactor includes more than one pipelines, the pipelines can be provided as interconnected pipelines in fluid communication with one another. In some implementations, still when the bioreactor includes more than one pipelines, the interconnected pipelines can be provided as a network of pipelines. The network can include pipelines that intersect each other at various angles. In some implementations, the one or more pipelines include at least one pipeline that is provided longitudinally. More details regarding this aspect are provided below.

The bioreactor is in fluid communication with a second oxygen-containing gas distribution system 34. The second oxygen-containing gas distribution system 34 enables supplying a second oxygen-containing gas 36 to the preparation reservoir. Similarly to the first oxygen-containing gas 30, the second oxygen containing-gas 36 can be any suitable gas that includes oxygen so that aerobic reactions within the stabilized livestock waste 16 can occur. In some implementations, the second oxygen-containing gas 30 can be air. Thus, in some implementations, the first oxygen-containing gas 30 can be the same as the second oxygen-containing gas 36, while in other implementations, the first oxygen-containing gas 30 can be different from the second oxygen-containing gas 36. Again, it is to be understood that when the second oxygen-containing gas 36 is air, the second oxygen-containing gas distribution system 34 is not necessarily a reservoir holding a given volume of gas. The second oxygen-containing gas distribution system 34 can be any system or device that is configured to introduce air in the stabilized livestock waste 16. For instance, the second oxygen-containing gas distribution system 34 can be an air distribution system, which will be described in further detail below.

Still referring to FIG. 1, the solid-liquid separation 22 can be performed for instance in any suitable structure or device that enables formation of a solid-enriched phase and a solid-depleted phase due to gravity forces. The solid-liquid separation can be performed to enable settling of the solid component of the aerated livestock product 20 to form the solid-enriched phase, while the liquid component forms the solid-depleted phase. In the present context, the expression “solid-enriched phase” is intended to mean a phase that is composed of a least a majority of solids in terms of volume. Similarly, the expression “solid-depleted phase” is intended to mean a phase that is composed of a least a majority of liquid in terms of volume. It is thus expected that the solid-enriched phase can include a portion of liquid therein, while the solid-depleted phase includes a portion of solids therein. Several options can be envisioned to enable the formation of the solid-enriched phase and of the solid-depleted phase. In some implementations, the aerated livestock waste 20 can be deposited in a settling tank, a decanter, a thickener, or a gravity settler. In other implementations, the aerated livestock waste 20 can be deposited in a pond. In yet other implementations, the aerated livestock waste 20 can be subjected to a solid-liquid separation using a centrifuge.

More details regarding each one of the preparation treatment, the bioreaction treatment and the solid-liquid separation are provided below.

### Preparation Treatment

As mentioned above, the process for treating a waste livestock can include a preparation treatment.

In the context of the present description, the expression “livestock waste” is intended to refer to waste produced by various animals that are part of livestock farming operations. For example, such animals can include swine, sheep, cattle and poultry. In the context of the present description, it is also to be noted that the expression “livestock waste” can be used interchangeably with the term “manure”. The livestock waste can include solids, which can include animal feces, and liquid, which can include animal urine and wastewater from farm operation, e.g., washing water and losses from animal drinkers.

When the livestock waste is subjected to the preparation treatment, the livestock waste can be used directly, e.g., without a previous treatment such a solid-liquid separation, dilution, or concentration. In such implementations, the livestock waste can be considered as a “raw livestock waste”. The raw livestock waste can thus advantageously be subjected to the preparation treatment without prior modification or treatment.

In other implementations, since the characteristics of the livestock waste can vary depending on various factors, the livestock waste can be subjected to one or more pre-treatments to arrive at a desired physicochemical characteristics and/or composition prior to further processing.

Examples of physicochemical properties of the livestock waste that may be valuable to determine prior to the preparation treatment can include the dissolved organic carbon (DOC), the dry matter content (DM), the total solids, the total suspended solids (TSS), the total dissolved solids (TDS), the total volatile solids (STV), the Kjeldahl nitrogen, ammoniacal nitrogen, and nitrate nitrogen. As will be discussed further below, these physicochemical properties can also be taken into consideration when adjusting and controlling the operating parameters of the preparation treatment.

Factors that can influence these physicochemical characteristics can include the type of animals, the age of the animals, the source of the livestock waste, e.g., whether it has been previously stored in a storage tank for a given period of time or if it used directly, the location from which it is withdrawn from the storage tank, and so on.

A pre-treatment can include for instance a dilution pre-treatment or a concentration pre-treatment, and/or mixing. In some implementations, the pre-treatment can thus contribute to achieve a given composition of the livestock waste, for instance in terms of dry matter, or concentration in solids. In some implementations, mixing the livestock waste can facilitate homogenizing the livestock waste prior to the preparation treatment.

The preparation treatment can include at least one of mixing the livestock waste, aerating the waste livestock, and heating the livestock waste, which can be performed simultaneously or sequentially. As mentioned above, an objective of the preparation treatment is to activate the aerobic microbial flora contained in the livestock waste, so that in turn, the performance of the bioreaction treatment can be improved. Accordingly, any treatment that can contribute to this objective can be considered within the scope of the present description.

In some implementations, mixing the livestock waste can be done via a mixing device placed within the preparation reservoir. In other implementations, mixing the livestock waste can be performed by recirculating the livestock waste via a recirculation loop, for instance using a pump. Mixing of the livestock waste can advantageously contribute to both homogenizing the livestock waste and aerating same.

Aerating the livestock waste can be performed according to various techniques. As mentioned above, the preparation reservoir can be in fluid communication with a first oxygen-containing gas distribution system 28. The first oxygen-containing gas distribution system 28 can include a Venturi device, and aerating the livestock waste 12 can include passing the livestock waste 12 through the Venturi device. In such implementations, the preparation reservoir can include a recirculation loop, which can be the same or different than the recirculation loop mentioned above, and the recirculation loop can include the Venturi device such that air can be suctioned-in and into the livestock waste 12.

In some implementations, the first oxygen-containing gas distribution system 28 can include any gas distribution system that can be placed within the preparation reservoir, to introduce the first oxygen-containing gas 30 into the livestock waste 12. The oxygen-containing gas distribution system 28 can include for instance a conduit that includes a plurality of openings or nozzles to introduce the first oxygen-containing gas 30 into the livestock waste 12. In some implementations, aerating the livestock waste 12 can be performed to avoid coalescence of air bubbles. In some implementations, aerating the livestock waste 12 can include producing fine bubbles, or microbubbles, within the livestock waste 12. In the context of the present description, the expression “fine bubbles” can refer to bubbles obtained following the passage of the oxygen-containing gas through the plurality of openings having a small diameter. Fine bubbles can be beneficial to enhance introduction and/or transfer of oxygen to the livestock waste.

In some implementations, it may be beneficial to provide heat to the livestock waste 12 during the preparation treatment 14 to potentiate the aerobic reactions that may be occurring in the livestock waste 12. In such implementations, heat can be supplied to the livestock waste 12 via any suitable means, such as by a heater, by providing isolation to the preparation reservoir, etc.

Operating Parameters of the Preparation Treatment

In some implementations, subjecting the livestock waste 12 to the preparation treatment 14 can include determining one or more properties of the livestock waste 12, and adjusting and/or controlling the operating parameters of the preparation treatment 14 in accordance with the determined one or more of the physicochemical properties of the livestock waste 12. Operating the preparation treatment 14 taking into consideration the characteristics of the livestock waste 12 can contribute to achieving a stabilized livestock waste 16 having resulting physicochemical properties within respective ranges.

Examples of operating parameters that can be controlled can include at least one of a temperature of the livestock waste within the preparation reservoir, a residence time of the livestock waste within the preparation reservoir, and a flow rate of the first oxygen-containing gas introduced into the livestock waste.

In some implementations, the preparation treatment 14 can be conducted such that the temperature of the livestock waste 12 can remain between 5° C. and 45° C. In other implementations, the preparation treatment 14 can be conducted such that the temperature of the livestock waste 12 can remain between 15° C. and 45° C. In other implementations, the preparation treatment 14 can be conducted such that the temperature of the livestock waste 12 can remain above 45° C.

In some implementations, the residence time of the livestock waste 12 in the preparation reservoir during the preparation treatment 14 can be at least 10 days. In other implementations, the residence time of the livestock waste 12 in the preparation reservoir during the preparation treatment 14 can be between 4 days and 30 days. In yet other implementations, the residence time of the livestock waste 12 in the preparation reservoir during the preparation treatment 14 can be less than 10 days. In yet other implementations, the residence time of the livestock waste 12 in the preparation reservoir during the preparation treatment 14 can be between 2 days and 12 days, or between 3 days and 10 days.

In some implementations, the flow rate at which the first oxygen-containing gas 30 is introduced in the livestock waste 12 during the preparation treatment 14, which can be expressed as liter of oxygen-containing gas per minute and per cubic meter of livestock waste (L O₂/min·m³), is between 5 L O₂/min·m³ and 40 L O₂/min·m³. In other implementations, the flow rate at which the first oxygen-containing gas 30 is introduced in the livestock waste 12 during the preparation treatment 14 is between 5 L O₂/min·m³ and 25 L O₂/min·m³. In yet other implementations, the flow rate at which the first oxygen-containing gas 30 is introduced in the livestock waste 12 during the preparation treatment 14 is between 0.1 L O₂/min·m³ and 5 L O₂/min·m³, between 0.2 L O₂/min·m³ and 2 L O₂/min·m³, or between 0.2 L O₂/min·m³ and 1 L O₂/min·m³.

In some implementations, introducing an oxygen-containing gas 30 into the livestock waste 12 can be performed intermittently. For instance, the oxygen-containing gas 30 can be introduced in the livestock waste 12 for a first period of time, followed by a second period of time during which no oxygen-containing gas 30 is introduced in the livestock waste 12, or is introduced at a reduced flow rate compared to the first period of time, and this cycle can be repeated until desired properties of the stabilized livestock waste 16 are achieved. For example, the first period of time can be between about 10 minutes to 30 minutes, and the second period of time can be between about 30 minutes and 60 minutes. In other implementations, introducing an oxygen-containing gas 30 into the livestock waste 12 can be performed continuously.

The resulting physicochemical properties of the stabilized livestock waste 16 can include at least one of the dissolved organic carbon of the stabilized livestock waste 16, the total solids of the stabilized livestock waste 16, the total suspended solids of the stabilized livestock waste 16, the total dissolved solids of the stabilized livestock waste 16, the total volatile solids of the stabilized livestock waste 16, the volatile suspended solids of the stabilized livestock waste 16, the biochemical oxygen demand of the stabilized livestock waste 16, the chemical oxygen demand of the stabilized livestock waste 16, the pH of the stabilized livestock waste 16, and the concentration of oxygen in the stabilized livestock waste 16.

In some implementations, the dissolved organic carbon of the stabilized livestock waste 16 can be between 20 000 mg/kg and 5 000 mg/kg, or between about 15 000 mg/kg and 3 000 mg/kg.

In some implementations, the total solids of the stabilized livestock waste 16 can be between 110 g/L and 160 g/L, or between 65 g/L and 160 g/L.

In some implementations, the total suspended solids of the stabilized livestock waste 16 are between 90 g/L and 130 g/L, or between 55 g/L and 130 g/L.

In some implementations, the total dissolved solids of the stabilized livestock waste 16 are between 12 g/L and 25 g/L.

In some implementations, the total volatile solids of the stabilized livestock waste 16 are between 90 g/L and 130 g/L.

In some implementations, the volatile suspended solids of the stabilized livestock waste 16 are between 80 g/L and 120 g/L, or between 3 g/L and 120 g/L.

In some implementations, the pH of the stabilized livestock waste 16 is between 5 and 9, between 6 and 8, or between 7 and 8.5.

In some implementations, the concentration of oxygen in the stabilized livestock waste 16 is below 1%, between 1% and 15%, or above 15%.

Additional physicochemical properties of the stabilized livestock waste 16 can include the Total Kjeldahl nitrogen (TKN) of the stabilized livestock waste 16, the ammoniacal nitrogen (N—NH₄⁺) of the stabilized livestock waste 16, and the nitrate nitrogen (N—NO₃⁻) of the stabilized livestock waste 16. In some implementations, the TKN of the stabilized livestock waste 16 can be between 6 000 mg/kg and 8 000 mg/kg, or between 5 500 mg/kg and 8 000 mg/kg. In some implementations, the ammoniacal nitrogen of the stabilized livestock waste 16 can be between 1 000 mg/kg and 5 000 mg/kg. In some implementations, the nitrate nitrogen of the stabilized livestock waste 16 can be between 0.10 and 2 mg/kg.

In some implementations, one or more of the physicochemical properties of the livestock waste 12 being subjected to the preparation treatment 14 can be monitored during the preparation treatment 14, and the operating parameters of the preparation treatment 14 can adjusted and/or controlled until a pre-determined criteria has been reached. For instance, in some implementations, variables known to be good indicators of the progression of the preparation treatment 14 can be monitored to ensure that the stabilized livestock waste 16 is in condition for being subjected to the bioreaction treatment 18. In some implementations, indicators of the progression of the preparation treatment 14 can include for instance at least one of the temperature of the livestock waste 12, the pH of the livestock waste 12, the concentration in oxygen of the livestock waste 12, and the biochemical oxygen demand at five days (BOD5). The BOD5 is a measure that corresponds to the amount of oxygen that aerobic bacteria and other aerobic microorganisms consume in a sample during a period of 5 days at a temperature of 20° C. For instance, in some implementations, one or more of the temperature, the pH, the oxygen concentration and the BOD5 can be monitored at given time intervals, and one or more operating parameters of the preparation treatment 14 such as the flow rate of oxygen introduced into the livestock waste 12, the heating, and the duration (or residence time) can be adjusted accordingly.

The stabilized livestock waste 16, which includes solids and liquid, can then be used without further transformation to be subjected to the bioreaction treatment 18.

In particular, in some implementations, the stabilized livestock waste 16 can be subjected to the bioreaction treatment 18 without being priorly subjected to a solid-liquid separation. In other words, the stabilized livestock waste 16 can retain both solid and liquid phases and be subjected as is to the bioreaction treatment 18.

In some implementations, the preparation treatment 14 can ensure that the stabilized livestock waste 16 provided as feedstock to the bioreaction treatment 18 is within a given specification to enhance performance of the bioreaction treatment 18 and to provide stable conditions to the aerobic microbial flora. In turn, the preparation treatment 14 can contribute to avoid formation of foam during the bioreaction treatment 18, and the accumulation of NH₄⁺ or NO₃⁺.

In some implementations, a retention reservoir can be used to store the stabilized livestock waste 16 prior to the bioreaction treatment 18.

### Bioreaction Treatment

Following the preparation treatment 14, the stabilized livestock waste 16 can be subjected to a bioreaction treatment 18. An objective of the bioreaction treatment 18 is to provide oxygen to the stabilized livestock waste 16 to enable and support aerobic reactions to occur. In turn, the aerobic reactions reduce biodegradable organic matter present in the stabilized livestock waste 16 via oxidation reactions that produce water, carbon dioxide (CO₂) and simple molecules. Examples of biodegradable organic matter include volatile fatty acids (VFA), which are generally responsible of unpleasant odours associated with livestock waste. Aerobic reactions also enable nitrification-denitrification reactions, which can be beneficial in the context of livestock waste processing and related production of fertilizers. In nitrification reactions, NH₄⁺ produces NO₂⁻ which in turn can produce NO₃⁻. In denitrification reactions, NO₃⁻ produces N₂, or undesirable N₂O in cases of incomplete denitrification. It is to be understood that in other implementations, the preparation treatment 14 can be omitted, and the feedstock for the bioreaction treatment 18 can be the livestock waste 12 that has been subjected to a pre-treatment or not. Thus, when referring to the stabilized livestock waste 16 in the following paragraphs, it is to be understood that it can also refer to the livestock waste 12.

Bioreactor

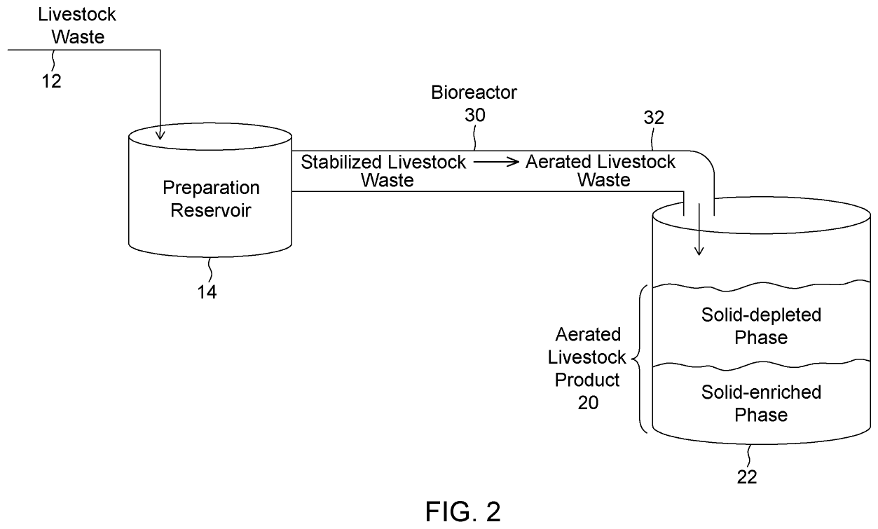

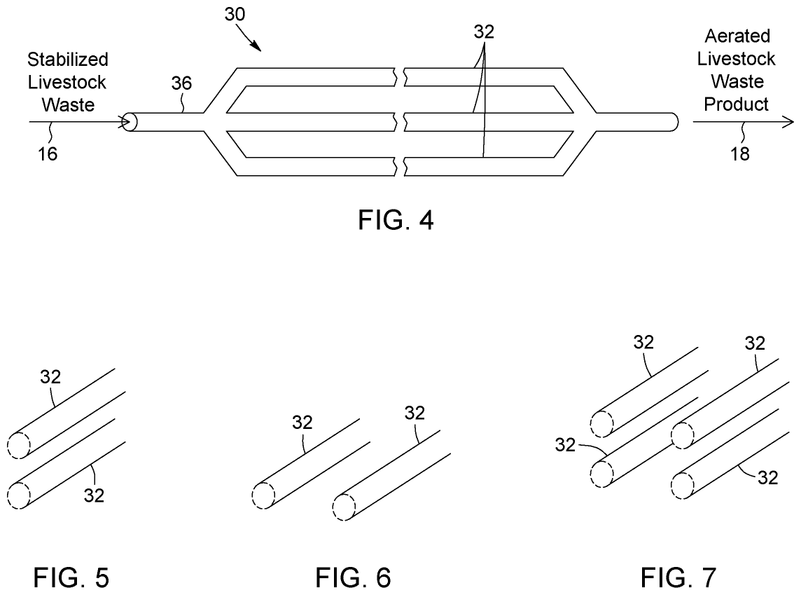

With reference now to FIGS. 2-17, the bioreaction treatment 18 can be performed in a bioreactor 30. The bioreactor 30 can include a pipeline 32 configured to receive the stabilized livestock waste 16 from the preparation treatment 14 therein. In some implementations, the pipeline 32 can include a plurality of pipelines that are interconnected and in fluid communication with one another. In some implementations, the plurality of pipelines can form a network of interconnected pipelines, such as shown in FIGS. 4-7 for instance.

In some implementations, at least one pipeline 32 can be provided to extend longitudinally along a ground surface 34. In the context of the present description, the term “longitudinally” is considered to mean that at least a portion of the pipeline 32 is provided in a substantially horizontal configuration, or within a deviation of at most 45° from a horizontal plan formed by the ground surface 34.

In some implementations, when a plurality of pipelines 32 is provided, at least two pipelines 32 can be provided in a superposed configuration, e.g., one above the other (see for instance FIG. 5). In other implementations, the plurality of pipelines 32 can be provided in a side-by-side configuration (see for instance FIG. 6). In some implementations, the plurality of pipelines 32 can include pipelines provided in a superposed configuration and in a side-by-side configuration (see for instance FIG. 7).

In some implementations, the bioreactor 30 can include a main pipeline 36 that divides into at least two pipelines 32, such as shown in FIG. 4 for instance.

In some implementations, the number of pipelines 32 forming the bioreactor 30 and their respective length can be determined to achieve a given overall length, or resulting length, of the bioreactor 30. For instance, in one scenario, the bioreactor 30 can include a single pipeline having a length X, while in another scenario, the bioreactor 30 can include five pipelines each having a X/5 length.

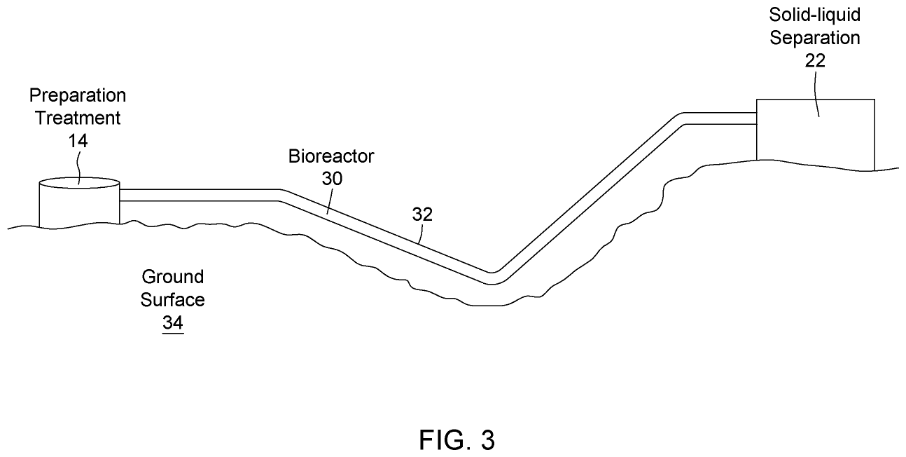

In some implementations, when the process for treating a livestock waste 10 can include sequentially a preparation treatment 14, a bioreaction treatment 18 and a solid-liquid separation 22, the bioreactor 30 can include the pipeline connection that ensures fluid communication between the preparation reservoir and the solid-liquid separation unit. In such implementations, the stabilized livestock waste 16 is thus transported via one or more pipelines 32 extending from the preparation reservoir to the solid-liquid separation unit, and is subjected to conditioning during transportation, which includes aeration of the stabilized livestock waste 16. In such implementations, when the bioreactor 30 provides fluid communication between the preparation reservoir and the solid-liquid separation unit, the configuration of the pipelines 32 can be determined in accordance with variations in the terrain between the preparation reservoir and the solid-liquid separation unit, in terms of the ground surface orientation, such as shown in FIG. 3. The bioreactor 30 can thus include one or more portion of a pipeline 32 that is provided in a downhill configuration, and/or one or more portion that is provided in an uphill configuration, to adjust to the variations in the terrain.

In other implementations, a section or all of the pipeline(s) can be provided in a receptacle, such as a container, and can have a configuration that is independent of the terrain onto which the receptacle is to be installed. In such implementations, the receptacle can be movable and be transported from one location to another depending on the needs.

Various diameters of pipelines 32 can be used to form the bioreactor 30. The bioreactor 30 can include pipelines 32 having the same diameter, or can include at least two pipelines 32 that have a different diameter from one another. In some implementations, at least one pipeline 32 can have a diameter ranging between 70 cm to 120 cm. In some implementations, at least one pipeline 32 can have a diameter ranging between 80 cm to 100 cm, between 50 cm to 100 cm, or between 60 cm to 95 cm.

In some implementations, the length and/or diameter of the pipelines 32 can be chosen according to the volume of stabilized livestock waste 16 to treat, and/or the desired residence time of the stabilized livestock waste 16 in the bioreactor 30.

The one or more pipelines 32 can be fluidly connectable to at least one pump that is operable to displace the stabilized livestock waste 16 from one location to the other, e.g., from one end of the bioreactor 30 up to the discharge location of the bioreactor 30. In some implementations, the flow rate of the stabilized livestock waste 16 circulating in the pipeline(s) 32 of the bioreactor 30 can be between 0.1 m³/hr and 3 m³/hr, or between 0.1 m³/hr and 0.5 m³/hr. For instance, for an agricultural operation that produces 12 m³ of livestock per day, the bioreactor 30 can be configured to receive 12 m³ per day, either continuously or in batch, with the stabilized livestock waste 16 being circulated in the bioreactor 30 to achieve a given residence time therein, for instance a residence time in the bioreactor 30 of between 5 and 15 days, between 7 and 12 days, or between 8 and 10 days.

In some implementations, the flow regimen of the stabilized livestock waste 16 circulating in the bioreactor 30 can be chosen to be turbulent to enhance mixing of the stabilized livestock waste 16 and facilitate contact with oxygen molecules. In other implementations, the flow regimen of the stabilized livestock waste 16 circulating in the bioreactor 30 can be chosen to be laminar.

Second Oxygen-Containing Gas Distribution System

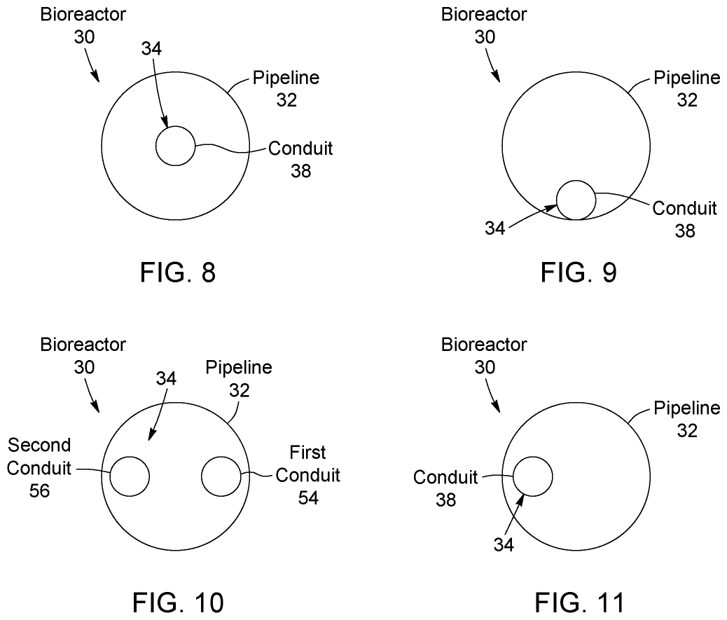

With reference now more particularly to FIGS. 8-17, the bioreactor 30 can include an oxygen-containing gas distribution system 34 that includes at least one conduit 38 extending along a length of, or longitudinally within the pipeline 32 of the bioreactor 30. The conduit 38 thus has a smaller diameter than the diameter of the corresponding pipeline 32 into which it extends in order to fit therein. The conduit 38 can include a plurality of openings 40 provided in a spaced-apart relationship and that are configured for enabling release of the oxygen-containing gas therethrough and into the stabilized livestock waste 16 circulating within the corresponding pipeline 32. The conduit 38 and corresponding pipeline 32 are thus provided in a concentric relationship, with the conduit 38 extending within the cavity of the corresponding pipeline 32.

In some implementations, the conduit 38 of the second oxygen-containing gas distribution system 34 can have a diameter ranging from 1 cm to 10 cm. In some implementations, the openings 40 defined in the conduit 38 can have a diameter ranging from 0.1 cm to 3 cm, or between 0.05 cm to 3 cm.

It is to be understood that the dimensions given above are for exemplification only, and that other dimensions of the pipeline(s) 32, the conduit 38 and the openings 40 can be suitable.

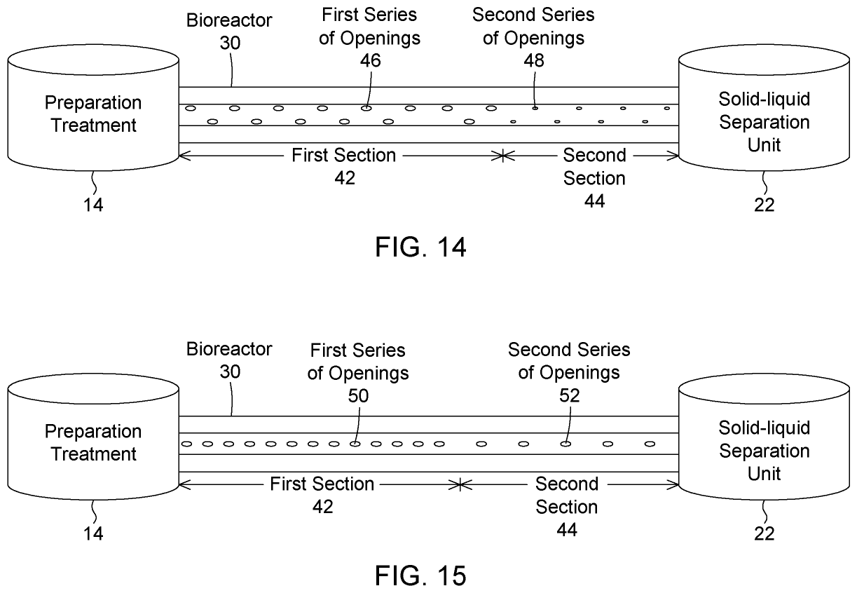

The openings 40 can have similar diameters or can have diameters that are different. For instance, the conduit 38 can include a first series of openings 46 that have a given diameter in a first section 42 of the bioreactor 30 that is closer to the preparation reservoir, and the conduit 38 can include a second series of openings 48 that have another diameter, different than the diameter of the openings of the first series of openings 46, in a second section 44 of the bioreactor 30 that is closer to the solid-liquid separation unit, such as shown for instance in FIG. 14. Similarly, the conduit 38 can include a first series of openings 50 that are provided at a given distance from one another in a first section 42 of the bioreactor that is closer to the preparation reservoir, and can include a second series of openings 52 that are provided at a different distance from one another compared to the distance between the openings of the first series of openings 50 in a second section 44 of the bioreactor 30 that is closer to the solid-liquid separation unit, such as shown in FIG. 15.

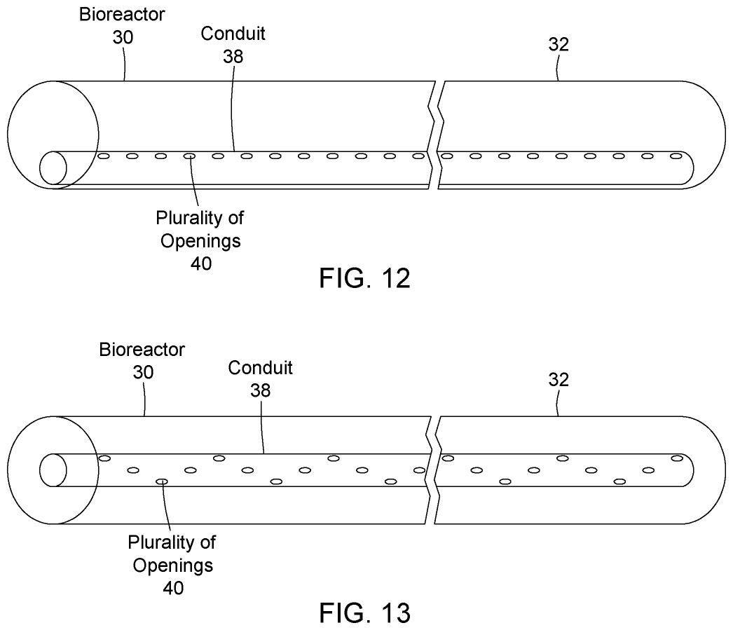

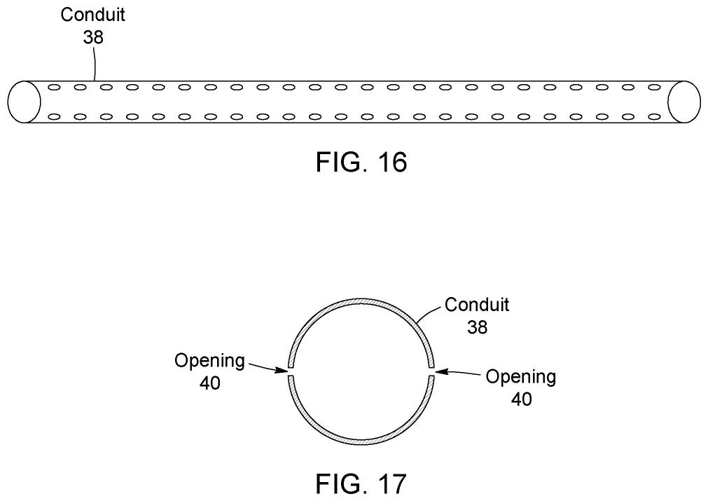

In some implementations, the openings 40 can be distributed around an entire periphery of the conduit. In some implementations, the openings 40 can be provided in an array along the length of the conduit, e.g., a substantially longitudinal array, such as shown in FIG. 12. In some implementations, the plurality of openings 40 can be provided as more than one arrays of openings. For instance and as shown in FIGS. 16 and 17, the plurality of openings 40 can be provided as two arrays of openings that are disposed in a diametrically opposed configuration. The plurality of openings 40 can thus be provided as at least two arrays provided in a 3 o'clock and 9 o'clock configuration. The plurality of openings 40 can also be provided as at least two arrays provided in a 4 o'clock and 8 o'clock configuration. It is to be understood that the two of more arrays of openings can be provided at any locations around the periphery of the conduit 38 to facilitate introducing the oxygen-containing gas 36 into the stabilized livestock waste 16.

In other implementations, the openings 40 can be distributed according to a given pattern or can be distributed randomly around the outer periphery of the conduit 38. In some implementations, the openings 40 can be provided in an array that spirals around the periphery of the conduit 38, such as shown in FIG. 13.

The number of openings and the distance between adjacent openings of the plurality of openings 40 can vary according to various factors. In some implementations, the distance between adjacent openings of the plurality of openings 40 can be for instance between 0.1 cm and 3 cm. In some implementations, the distance between adjacent openings of the plurality of openings 40 can be between 1 cm and 2 cm.

The conduit 38 can be provided at any location within the cavity of the corresponding pipeline 32. For instance, the conduit 38 can extend in a central region of the cavity. In such implementations, the openings 40 of the conduit 32 can be provided around the periphery of the conduit 32 to facilitate the introduction of the oxygen-containing gas around the conduit 32 such that the oxygen-containing gas can be released radially therefrom. In other implementations, the conduit 32 can extend along and close to an inside surface of the corresponding pipeline 32, such as shown in FIGS. 9 and 11. In such implementations, the plurality of openings 40 can be provided as an array located toward the center of the cavity of the corresponding pipeline 32. It is to be understood that the conduit 38 can also be provided at any location along the radius of the corresponding pipeline 32, and can have any configuration of openings 40 to release the oxygen-containing gas therefrom.

With reference to FIG. 10, in some implementations, more than one conduit can be provided within the corresponding pipeline. For example, a first conduit 54 can be provided alongside an inside surface of the corresponding pipeline 32 at a 3 o'clock location, and a second conduit 56 can be provided alongside an inside surface of the corresponding pipeline at a 9 o'clock location. In some implementations, one or more conduits can be provided alongside an inside surface of the corresponding pipeline 32, and one or more conduits can be provided in a central region of the cavity of the cavity of the corresponding pipeline 32.

In some implementations, the bioreaction treatment 18 can be conducted in batch, while in other implementations, the bioreaction treatment 18 can be performed continuously. Whether the bioreaction treatment 18 is performed in batch or continuously can depend for instance on the availability of the stabilized livestock waste 16, and whether a retention reservoir is used to store the stabilized livestock waste 16. In some implementation, the availability of the stabilized livestock waste 16 as feedstock for the bioreaction treatment 18 can be made more constant with the use of a retention reservoir to store the stabilized livestock waste 16.

The oxygen-containing gas distribution system 34 can further include a pump for pumping oxygen-containing gas into the conduit 38. When the oxygen-containing gas is air, the pump can be for instance a piston pump, a rotary vane pump or a diaphragm pump. A compressor can also be used. Any device capable of providing a desired flow rate of the oxygen-containing gas to the stabilized livestock waste 16 can be envisioned in the context of the present description. In some implementations, the conduit 38 can include an anti-return valve to prevent backflow of the oxygen-containing gas. More than one pump can be used, depending for instance of the volume of stabilized livestock waste 16 and on the resulting length of the bioreactor 30. The type and/or number of pumps can also be determined so as to obtain a desired flow rate of the oxygen-containing gas introduced into the stabilized livestock waste 16 within the pipeline 32, which can be expressed as liter of oxygen-containing gas per minute and per cubic meter of stabilized livestock waste (L O₂/min·m³). In some implementations, the flow rate of the oxygen-containing gas introduced into the stabilized livestock waste 16 can be at least 10 L/min·m³. In some implementations, the flow rate of the oxygen-containing gas introduced into the stabilized livestock waste 16 can be between 5 L O₂/min·m³ and 60 L O₂/min·m³. In some implementations, the flow rate of the oxygen-containing gas introduced into the stabilized livestock waste 16 can be between 10 L O₂/min·m³ and 50 L O₂/min·m³. in some implementations, the flow rate of the oxygen-containing gas introduced into the stabilized livestock waste 16 can be between 2 L O₂/min·m³ and 8 L O₂/min·m³. In some implementations, the flow rate of the oxygen-containing gas can be chosen to achieve a given concentration of oxygen in the resulting aerated livestock product 20.

In some implementations, the flow rate of the oxygen-containing gas can be chosen to ensure an equilibrium between removal of organic matter through decomposition of the volatile fatty acids and the nitrification-denitrification reactions occurring within the stabilized livestock waste 16, to avoid an increase in the emission of nitrogen species in the form of NH₃ and N₂O.

The flow rate of the oxygen-containing gas can be chosen to enable aerobic reactions to occur in the stabilized livestock waste during the residence time of the stabilized livestock waste 16 in the pipeline(s) 32 of the bioreactor 30 so that the aerated livestock product 20 can be discharged therefrom with desired characteristics, for instance in terms of concentration of phosphorus, concentration of nitrogen, removal of organic matter, BOD5 and COD.

In some implementations, aerating the stabilized livestock waste 16 can be performed intermittently. For instance, the oxygen-containing gas 36 can be introduced in the stabilized livestock waste 16 for a first period of time, followed by a second period of time during which no oxygen-containing gas 36 is introduced in the stabilized livestock waste 16, or is introduced at a reduced flow rate compared to the first period of time, and this cycle can be repeated until desired properties of the aerated livestock product 20 are achieved. In other implementations, aerating the stabilized livestock waste 16 can be performed continuously.

In some implementations, the aerated livestock product 20 that comprises a solid phase and a liquid phase is suitable for use directly as a fertilizer, i.e., a fertilizer that includes a solid phase that is phosphorus-enriched and a liquid phase that is nitrogen-enriched. In such implementations, given the solid and liquid phases of the aerated livestock waste 20, the aerated livestock waste 20 can be agitated prior to use.

In other implementations, the aerated livestock product 20 can be subjected to a solid-liquid separation 22 to obtain a solid-enriched phase comprising predominantly the solid component and a solid-depleted phase comprising predominantly the liquid component of the aerated livestock product 20. Subjecting the aerated livestock product 20 to a solid-liquid separation 22 can include settling the aerated livestock product 20 in a settling reservoir. For instance, the aerated livestock product 20 can be discharged from the bioreactor 30 in a settling reservoir to allow solids from the solid phase to settle by gravity at the bottom of the settling reservoir, while the liquid phase remains as a top layer above the settled solids. In some implementations, the solid-enriched phase of the aerated livestock product 20 can represent approximately 50% v/v of the aerated livestock product 20. In other implementation, the solid-enriched phase of the aerated livestock product 20 can represent approximately 30% v/v of the aerated livestock product 30 and the solid-depleted phase can represent approximately 70% v/v of the aerated livestock product 20.

Any other type of solid-liquid separation suitable to separate a solid-enriched phase from a solid-depleted phase of the aerated livestock product 20 can also be envisioned. For example, the solid-liquid separation 22 can be performed in a decanter, a gravity settler, a pond, a thickener, or a centrifuge such as a decanter centrifuge.

When the solid-liquid separation 22 occurs by settling, a portion of the solid-enriched phase can be retrieved from the until used for settling to obtain a solid-enriched stream 24, and a portion of the solid-depleted phase can also be retrieved therefrom to obtain a solid-depleted stream 26. The solid-enriched phase that has been separated from the aerated livestock product 20 can be used directly as a solid fertilizer comprising nitrogen and a higher concentration of phosphorus compared to the concentration of phosphorus in the solid-depleted phase. The solid-enriched phase can also be further treated to produce the solid fertilizer, which can include drying or composting. The phosphorus content of the solid-enriched phase can represent for instance 65% to 85% of the phosphorus initially present in the livestock waste. The concentrations of phosphorus in the aerated livestock product 20 can depend on the initial concentration of phosphorus in the livestock waste being subjected to the bioreaction treatment 18. In some implementations, the concentration of phosphorus of the solid-enriched phase can be between 800 mg/kg and 10 000 mg/kg, or between 1000 mg/kg and 10 000 mg/kg. The solid-depleted phase that has been separated from aerated livestock product 20 can be used directly as a liquid fertilizer comprising phosphorus and higher a concentration of nitrogen compared to the concentration of nitrogen in the solid-enriched phase. The solid-depleted phase can also be further treated to produce a liquid fertilizer.

Several alternative implementations and examples have been described and illustrated herein. The implementations of the technology described above are intended to be exemplary only. A person of ordinary skill in the art would appreciate the features of the individual implementations, and the possible combinations and variations of the components. A person of ordinary skill in the art would further appreciate that any of the implementations could be provided in any combination with the other implementations disclosed herein. It is understood that the technology may be embodied in other specific forms without departing from the central characteristics thereof. The present examples and implementations, therefore, are to be considered in all respects as illustrative and not restrictive, and the technology is not to be limited to the details given herein. Accordingly, while the specific implementations have been illustrated and described, numerous modifications come to mind.

### EXPERIMENTATION

Various experiments were conducted to illustrate some characteristics of the process and system for treating a livestock waste described herein. Description of experiments performed, and corresponding results are presented below.

An experiment was conducted to assess the performance of the preparation treatment in producing a stabilized livestock waste from a livestock waste.

In the experiment, the preparation treatment was performed in a preparation reservoir having a volume of 1 000 liters. The preparation reservoir was connected to a pipeline to form a first recirculation loop that included a Venturi device, and to another pipeline to form a second recirculation loop for increased mixing of the livestock waste. The preparation reservoir was connected to a pump configured for circulating the livestock waste through the first recirculation loop and the second circulation loop. The diameter of the pipeline of the first circulation loop and of the second recirculation loop was approximately 2 inches. The diameter of the Venturi system was also of approximately 2 inches. A flowmeter with a flowing body was installed at the opening of the air inlet of the Venturi system to measure the flowrate of the air suctioned into the livestock waste. The second recirculation loop was equipped with a valve to control the flowrate of the livestock circulating in the second recirculation loop, which also indirectly enables control of the volume of livestock waste circulating in the first recirculation loop. In this experiment, the exit of the first recirculation loop and the exit of the second recirculation loop were positioned so as to be diametrically opposite from each other to enhance the mixing of the livestock waste. The volume of livestock waste inside the preparation reservoir was approximately 700 liters, which was chosen to leave a space over the volume of the livestock waste in case of foam formation during the preparation treatment. In that regard, the exit of the second recirculation was placed slightly above the livestock waste level in the preparation reservoir to help in breaking up formation of foam. The exit of the first recirculation loop was placed at the bottom of the preparation reservoir to facilitate mixing of the livestock waste and favor aeration of the livestock waste.

The experiment was conducted for 15 days. During these 15 days, the operation of the pump was performed according to 45 minutes cycles, i.e., the pump was turned on for 45 minutes and then turned off for 45 minutes and so on.

Data was collected throughout the experimentation to evaluate the aeration of the livestock waste. The data collected included the temperature, the pH, the total solids, the total volatile solids, the total suspended solids, the total dissolved solids, the volatile suspended solids, the dry matter, the dissolved organic carbon, the total Kjeldahl nitrogen, the ammoniacal nitrogen, and the nitrate nitrogen of the stabilized livestock waste.

In addition, in order to determine the extent of the organic matter removal, the biochemical oxygen demand (BOD) and the chemical oxygen demand (COD) were also measured.

The samples were analyzed at given timepoints during the 15 days of the experiments, at day 0, day 2, day 5, day 10 and day 15. At these timepoints, the samples were taken from the bottom of the preparation reservoir. In addition, on day 15, a sample was also taken from the surface of the stabilized livestock waste to evaluate the homogeneity of the stabilized livestock waste.

### Results

Table 1 below details the physicochemical properties of the livestock waste that was subjected to the preparation treatment.

TABLE 1
Physicochemical properties of the livestock waste

| | | | Total | Total | Total | | | | Dissolved |
|---|---|---|---|---|---|---|---|---|---|
| | Dry | Total | suspended | dissolved | volatile | | | | organic |
| | Matter | Solids | solids | solids | solids | TKN | N-NH₄⁺ | N-NO³⁻ | carbon |
| pH | (%) | (g/L) | (g/L) | (g/L) | (g/L) | (mg/kg) | (mg/kg) | (mg/kg) | (mg/kg) |
| 6.89 | 11.90 | 137.00 | 109.00 | 13.9 | 106 | 7227 | 3677 | 0.87 | 17714 |

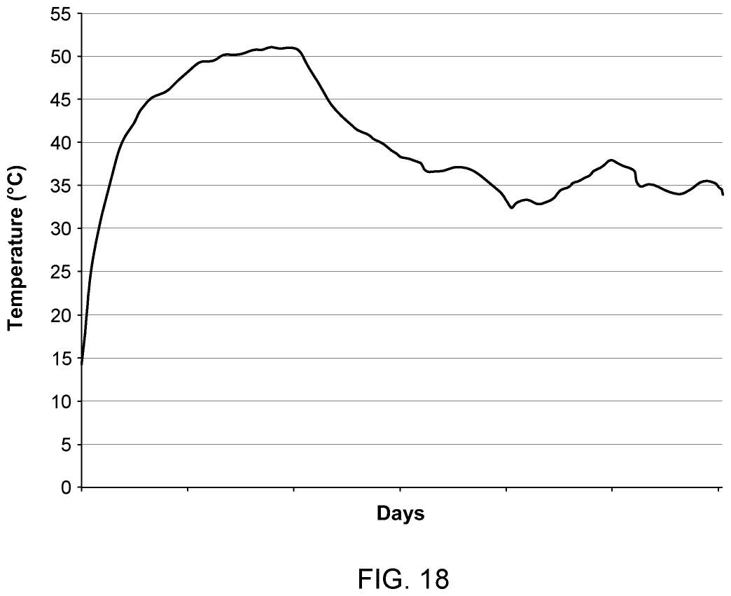

With reference to FIG. 18, the temperature data obtained during the experiment illustrates that the temperature was increased during the first 5 days of the experiment, which shows that the aeration of the livestock waste was sufficient to support the aerobic bacterial activity in the livestock waste. More precisely, the temperature of livestock waste was increased from approximately 15° C., which corresponds to the ambient temperature surrounding the preparation reservoir when the experiment was performed, to a temperature of approximately 50° C. after 5 days of the experiment. The temperature then decreased to temperatures ranging between approximately 35° C. and approximately 45° C. The preparation reservoir thus transitioned from a mesophilic environment, i.e., an environment where the temperature is between 5° C. and 45° C., to a thermophilic environment, i.e., an environment where the temperature is above 50° C., within 5 days. Fluctuations in temperatures during the experiment, especially following the first 5 days of the experiment, can be explained at least in part by variations in the ambient temperature depending on the temperatures outside of where the preparation reservoir was stored, i.e., the outdoor temperature. Overall, it was determined that the increase in temperature observed during the preparation treatment indicated an efficient and sufficient aeration of the livestock waste.

Referring back to Table 1, the analysis of the physicochemical properties of the livestock waste reveals a high content of solids and nitrogen. This can be explained at least in part due to the provenance of the livestock waste, which was taken from the bottom of a storage tank. Such a high solid content could have impaired the efficiency of the aeration of the livestock waste, since a high solid content generally correlates with a high organic matter content. However, even with this high solid content and as mentioned above, it appears that the aeration reached sufficient levels to support the aerobic activity within the livestock waste.

Regarding the amount of air that was introduced into the livestock waste, the data obtained from the flowmeter indicates that the air suctioned-in by the Venturi varied from 9.44 L/min. and 14.16 L/min. between day 0 and day 5, and from 14.16 L/min. and 18.18 L/min. between day 5 and day 15. In total, during the 15 days of the experiment, it was determined that approximately 153 000 L of air was suctioned-in by the Venturi into the livestock waste, which can be estimated to correspond to approximately 33 000 L of oxygen. It was then estimated that approximately 1.5 L/min. of oxygen was introduced into the livestock waste, which corresponds to approximately 2.30 L/min per each m³ of livestock waste.

An objective of the experiment was to create an environment that would be favorable to the activation of the aerobic microbial flora and to initiate the removal of organic matter. Data shown in Table 2 and Table 3 below provides some insights regarding this objective.

TABLE 2
Evolution of physicochemical properties of the livestock waste subjected to the
preparation treatment

| | | Total | Total | | Total | | | Dissolved |
|---|---|---|---|---|---|---|---|---|
| | | suspended | dissolved | | volatile | | Volatile | organic |
| | Total Solids | solids | solids | TSS + | solids | | suspended | carbon |
| Day | (g/L) | (g/L) | (g/L) | TDS | (g/L) | TS-TVS | solids | (mg/kg) |
| 0 | 137.00 | 109.00 | 13.9 | 122.90 | 106 | 31.00 | 91.7 | 17714 |
| 2 | 127.00 | 112.00 | 19.5 | 131.50 | 103 | 24.00 | 96.5 | 19061 |
| 5 | 126.00 | 102.00 | 15.0 | 117.00 | 101 | 25.00 | 86.3 | 18837 |
| 10 | 150.00 | 128.00 | 19.2 | 147.20 | 119 | 31.00 | 107 | 14351 |
| 15 | 148.14 | 122.34 | 18.5 | 140.84 | 122 | 26.14 | 102 | 12590 |
| (bottom) | | | | | | | | |
| 15 | 122.71 | 108.36 | 15.3 | 123.66 | 105 | 17.71 | 90 | 7775 |
| (top) | | | | | | | | |

According to the data that was gathered, the dissolved organic carbon decreased significantly starting on day 10 of the experiment. It is hypothesized that the reduction in the dissolved organic carbon correlated with a reduction in the biochemical oxygen demand (BOD) at day 5 under controlled conditions (BOD5), which is an indirect measure of the sum of biodegradable organic substances in the sample. Although the BOD5 was not evaluated per se, the reduction in the dissolved organic carbon appears to indicate that removal of organic matter was occurring starting approximately on day 10 of the experiment.

It was observed that the solid content did not appear to be significantly affected during the course of the preparation treatment. A hypothesis made with regard to this observation is that the increase in the aerobic microbial flora resulting from the aeration by the Venturi could compensate the reduction in organic matter.

The comparison between the data obtained from the samples respectively taken from the bottom and the top of the stabilized livestock waste at day 15 shows that the stabilized livestock has a lower solid content. This appears to show that the configuration of the preparation reservoir, with the pump, and the first and second recirculation loop, could still be optimized to achieve a better homogenization.

TABLE 3
Additional physicochemical properties of the livestock
waste subjected to the preparation treatment

| | | TKN | N—NH₄⁺ | N—NH₄⁺/ | N—NO₃⁻ |
|---|---|---|---|---|---|
| Day | pH | (mg/kg) | (mg/kg) | TKN | (mg/kg) |
| 0 | 6.89 | 7227 | 3677 | 51% | 0.87 |
| 2 | 7.09 | — | — | — | — |
| 5 | 8.45 | 7257 | 3862 | 53% | — |
| 10 | 8.54 | 6805 | 2308 | 34% | 0.96 |
| 15 | 8.40 | 6765 | 1734 | 26% | 0.73 |
| (bottom) | | | | | |
| 15 | 8.40 | 6666 | 1643 | 25% | 0.52 |
| (top) | | | | | |

The pH of the livestock waste increased up to day 5 to then stabilize at approximately 8.45. This increase in pH can be explained at least in part by the removal of the volatile fatty acids and/or the release of CO₂. Regarding the various nitrogen values obtained, it may be worth mentioning that ammoniacal nitrogen N—NH₄⁺ is in equilibrium in the livestock waste according to the relationship NH₄⁺═NH₃+H⁺. Given the rise in temperature and the agitation in the preparation reservoir, it was thus expected to observe a decrease in ammoniacal nitrogen N—NH₄⁺ in favor of ammonia volatilization.

An increase in nitrate nitrogen NO₃⁻ was observed between day 0 and day 5, to then return close to its baseline level at day 10 and then decrease at day 15. These variations in the nitrate nitrogen values could be due to various nitrification-denitrification reactions occurring simultaneously in the livestock waste, which in turn could favor a decrease in the ammoniacal nitrogen N—NH₄⁺. In addition, a malfunctioning of the Venturi between day 8 and day 10 may have caused the livestock waste to be in anaerobic conditions during this period of time, which may have favored denitrification reactions and could explain the rapid drop in the nitrate nitrogen levels thereafter. In addition, no significant differences were observed in the various data obtained relative to nitrogen whether the samples were taken from the bottom of the preparation reservoir or the top of the reservoir.

Another experiment was conducted to assess the performance of the preparation treatment in producing a stabilized livestock waste from a livestock waste in a substantially continuous mode.

The experiment was conducted using a system that included a preparation reservoir and a bioreactor. The preparation reservoir had a volume of 2200 liters. The preparation reservoir was connected to a pipeline to form a recirculation loop that included a Venturi device to aerate the livestock waste. The preparation reservoir was also connected to a pump configured for circulating the livestock waste through the recirculation loop. The diameter of the pipeline of the recirculation loop was approximately 2 inches. The diameter of the Venturi system was also of approximately 2 inches. A flowmeter with a flowing body was installed at the opening of the air inlet of the Venturi system to measure the flowrate of the air suctioned into the livestock waste. The recirculation loop was equipped with a valve to control the flowrate of the livestock circulating, and consequently the flowrate of the air suctioned. The volume of livestock waste inside the preparation reservoir was approximately 1500 liters, which was chosen to leave a space over the volume of the livestock waste in case of foam formation during the preparation treatment. The exit of the recirculation loop was placed at the bottom of the preparation reservoir to facilitate mixing of the livestock waste and favor aeration of the livestock waste. The experiment was performed for 16 days, during which the operation of the pump was performed according to a 12 minutes-48 minutes cycle, i.e., the pump was turned on for 12 minutes and then turned off for 48 minutes and so on.

The bioreactor included a pipeline having a diameter of 36 inches and a length of 23 feet, and at each end included a portion extending upwardly to form an elbow. The bioreactor thus had an opening of a diameter of 36 inches at the top of each elbow. The bioreactor had a capacity of about 4500 liters. The livestock waste was aerated using an oxygen-containing gas distribution system placed at the bottom of the preparation reservoir, to introduce gas into the livestock waste, which in this experiment was air. The oxygen-containing gas distribution system included a conduit having a diameter of ½ inch. The conduit included two rows of openings at ½ inch space to introduce air into the livestock waste. Two rows of the conduit were provided within the bioreactor, such that a total of about 46 feet of conduit was extending within the bioreactor. The aeration was performed to produce fine bubbles of air in the livestock waste, and the air exited the bioreactor at the top of each elbow. The air flowrate in the conduit was about 113 liters of air per minute, corresponding about to 25 liters of air per minute per cubic meter of livestock waste present in the bioreactor.

As mentioned above, the experiment was conducted for 16 days to assess the performance of a prototype of a system for treating livestock waste as described herein that is configured for operating in a substantially continuous mode. Once per day, about 500 liters of raw livestock waste were pumped into the preparation reservoir, about 500 liters of stabilized livestock waste were pumped from the preparation reservoir to one side of the bioreactor, and about 500 liters of an aerated livestock product were pumped from the other side of the bioreactor and sent to a settling reservoir. Prior to the beginning of the 16 days experiment, the preparation reservoir and the bioreactor were filled with raw livestock waste, and the cycle described above was run 10 days in order to stabilize the treatment system.

Data was collected throughout the experiment to evaluate the performance on the aeration of the livestock waste. Livestock waste samples were taken at the following points in the system: in the raw livestock waste container, in the preparation reservoir, at the exit of the bioreactor, and in the settling reservoir, at both the surface and the bottom thereof. The data collected included the temperature, the dissolved oxygen content, the pH, the dry matter content, the suspended solids, the volatile suspended solids, the dissolved organic carbon, the total Kjeldahl nitrogen, the ammoniacal nitrogen N—NH4⁺, the nitrate nitrogen N—NO₃⁻, and the mineral phosphorus and total phosphorus.

In addition, in order to determine the extent of the organic matter removal, the biochemical oxygen demand (BOD5) and the chemical oxygen demand (COD) were also measured.

In order to evaluate the hygienization of the livestock waste, the Escherichia coli (E. coli) and fecal coliforms count was analysed.

### Results

Table 4 and Table 5 below show the results from this experiment, at various timepoints throughout the experiment.

TABLE 4
Temperature and dissolved oxygen at different stages during
16 days of operation

| | Temperature | Dissolved oxygen | |
|---|---|---|---|
| Timepoint | ° C. | mg/L | % saturation |

Preparation reservoir

| | | | |
|---|---|---|---|
| Day 1 | 27.4 | 0.11 | 1.27 |
| Day 12 | 32.0 | 0.16 | 2.03 |
| Day 13 | 31.9 | 0.11 | 2.03 |
| Day 14 | 29.7 | 0.15 | 2.13 |
| Day 15 | 35.1 | 0.21 | 2.73 |
| Day 16 | 27.1 | 0.18 | 2.20 |
| Average | 30.5 | 0.15 | 2.07 |

Bioreactor

| | | | |
|---|---|---|---|
| Day 1 | — | 0.12 | 1.43 |
| Day 6 | 36.9 | 0.10 | 1.30 |
| Day 13 | 28.0 | 0.11 | 1.33 |
| Day 14 | 21.8 | 0.12 | 1.50 |
| Day 15 | 26.2 | 0.12 | 1.40 |
| Day 16 | 27.8 | 0.13 | 1.54 |
| Average | 28.1 | 0.12 | 1.42 |

TABLE 5
Chemical and biological analysis of slurry at different stages during 16 days of
operation

| | | | | | | | | |
|---|---|---|---|---|---|---|---|---|
| | | | Total | | | | | |
| | | | suspended | | Volatile | | | |
| | | | solids | Volatile | suspended | Total | | |
| | | Dry matter | (g/L) | solids | solid | nitrogen | N-NH₄⁺ | N-NO³⁻ |
| Timepoint | pH | (% w.b.) | % (w.b.) | (% d.b.) | % (w.b.) | (mg/kg) | (mg/kg) | (mg/kg) |

Raw livestock waste

| | | | | | | | | |
|---|---|---|---|---|---|---|---|---|
| Day 2 | 7.01 | 5.69 | 5.36 | 77.6 | 4.55 | 4863 | 2517 | 0.570 |
| Day 6 | 7.07 | 4.12 | 3.77 | 78.0 | 3.1 | 3688 | 1842 | 0.713 |
| Average | 7.04 | 4.91 | 4.57 | 77.8 | 3.83 | 4276 | 2180 | 0.642 |

Preparation reservoir

| | | | | | | | | |
|---|---|---|---|---|---|---|---|---|
| Day 2 | 7.43 | 3.31 | 2.96 | 74.9 | 2.39 | 3180 | 1983 | 2.240 |
| Day 16 | 6.89 | 2.08 | 2.06 | 77.7 | 1.71 | 1981 | 976 | 1.520 |
| Average | 7.16 | 2.70 | 2.51 | 76.3 | 2.05 | 2581 | 1480 | 1.880 |

Bioreactor output

| | | | | | | | | |
|---|---|---|---|---|---|---|---|---|
| Day 2 | 7.59 | 2.39 | 2.09 | 68.1 | 1.60 | 3196 | 2102 | 0.925 |
| Day 6 | 7.36 | 2.45 | 2.10 | 68.7 | 1.68 | 3234 | 2181 | 1.420 |
| Day 16 | 7.28 | 1.74 | 2.84 | 68.4 | 2.32 | 2435 | 1557 | 1.020 |
| Average | 7.41 | 2.19 | 2.34 | 68.4 | 1.87 | 2955 | 1947 | 1.122 |

Settling reservoir (surface)

| | | | | | | | | |
|---|---|---|---|---|---|---|---|---|
| Day 6 | 7.41 | 1.37 | 1.19 | 54.9 | 0.78 | 2592 | 1998 | 0.624 |
| Day 16 | 7.31 | 1.42 | N/A | 56.5 | N/A | 2046 | 1532 | 0.600 |
| Average | 7.36 | 1.395 | 1.19 | 55.7 | 0.78 | 2319 | 1765 | 0.612 |

Settling reservoir (Bottom)

| | | | | | | | | |
|---|---|---|---|---|---|---|---|---|
| Day 6 | 6.99 | 5.43 | 5.12 | 76.2 | 4.26 | 4218 | 2136 | 0.806 |
| Day 16 | 6.86 | 4.35 | N/A | 75.8 | N/A | 3383 | 1715 | 0.740 |
| Average | 6.925 | 4.89 | 5.12 | 76.0 | 4.26 | 3800.5 | 1925.5 | 0.773 |

TABLE 6
Chemical and biological analysis of slurry at different stages during 16 days of
operation

| | | | | | | | |
|---|---|---|---|---|---|---|---|
| | | | Dissolved | | | | |
| | Minera | Total | organic | | | | Total |
| | phosphorus | phosphorus | carbon | DBO5 | DCO | E. Coli | coliforms |
| Timepoint | (mg/kg) | (mg/kg) | mg/kg (w.b) | mg O2/l | mgO2/l | UFC/100 m | UFC/100 m |

Raw livestock waste

| | | | | | | | |
|---|---|---|---|---|---|---|---|
| Day 2 | 930 | 1067 | 7285 | NA | NA | NA | NA |
| Day 6 | 780 | 906 | 4482 | 23100 | 51100 | 570000000 | 110000000 |
| Average | 855 | 987 | 5884 | 23100 | 51100 | 570000000 | 110000000 |

Preparation reservoir

| | | | | | | | |
|---|---|---|---|---|---|---|---|
| Day 2 | 565 | 622 | 3489 | NA | NA | NA | NA |
| Day 16 | 420 | 508 | 4954 | 16,000 | 17,700 | NA | NA |
| Average | 493 | 565 | 4222 | 16000 | 17700 | NA | NA |

Bioreactor output

| | | | | | | | |
|---|---|---|---|---|---|---|---|
| Day 2 | 515 | 564 | 4146 | — | — | — | — |
| Day 6 | 493 | 549 | 4603 | 1200 | 30900 | 340000 | 600000 |
| Day 16 | 382 | 450 | 6681 | 14800 | 25800 | 620000 | 2700000 |
| Average | 463 | 521 | 5143 | 8000 | 28350 | 480000 | 1650000 |

Settling reservoir (surface)

| | | | | | | | |
|---|---|---|---|---|---|---|---|
| Day 6 | 125 | 166 | 3537 | 800 | 19100 | NA | NA |
| Day 16 | 96.2 | 130 | 5328 | 13200 | 15300 | NA | NA |
| Average | 110.6 | 148 | 4432.5 | 7000 | 17200 | NA | NA |

Settling reservoir (Bottom)

| | | | | | | | |
|---|---|---|---|---|---|---|---|
| Day 6 | 1439 | 1514 | 6372 | 20700 | 48200 | NA | NA |
| Day 16 | 1059 | 1205 | 8145 | 17200 | 49000 | NA | NA |
| Average | 1249 | 1359.5 | 7258.5 | 18950 | 48600 | NA | NA |

With reference to Table 4, the temperature data obtained during the experiment illustrates that the temperature in the preparation reservoir was maintained between 27.1° C. and 35.1° C. These results show that the aeration of the livestock waste in the preparation reservoir was sufficient to support the aerobic bacterial activity in mesophilic conditions. Mesophilic conditions were also maintained in the bioreactor, as the temperature varied from 21.8° C. to 36.9° C.

The dissolved oxygen content was maintained between 0.11 mg/l and 0.21 mg/l in the preparation reservoir, and between 0.10 mg/l and 0.13 mg/l in the bioreactor. The oxygen saturation was maintained between 1.27% and 2.73% in the preparation reservoir, and between 1.30% and 1.54% in the bioreactor. Lower dissolved oxygen content and lower oxygen saturation percentage in the bioreactor can be indicative of a higher oxygen consumption by aerobic bacteria present in the bioreactor.

With reference to Table 5, the pH of the raw livestock waste was between 7.01 and 7.07. The pH was increased up to 7.43 in the preparation reservoir, and up to 7.59 at the output of the bioreactor. This increase in pH can be explained at least in part by the removal of the volatile fatty acids and/or the release of CO₂ from the livestock waste.

The dry matter content, the total suspended solids, the volatile solids and the volatile suspended solids of the livestock waste decreased at each step subsequent step of the experimentation. These decreases can be indicative that the aerobic treatment can facilitate the sedimentation of particulates.

High sedimentation of particulates was confirmed in the settling reservoir as the dry matter content, the total suspended solids, the volatile solids and the volatile suspended solids of the slurry were significantly lower at the surface of the reservoir compared to the bottom of the reservoir.

On average, a decrease in total nitrogen and ammoniacal nitrogen N—NH₄⁺ was observed for the livestock waste in the preparation reservoir and at the output of the bioreactor, compared to the raw livestock waste. The decrease in ammoniacal nitrogen N—NH₄⁺ can be interpreted as corresponding to ammonia volatilization. An increase in nitrate nitrogen N—NO₃⁻ was observed in the preparation reservoir and at the output of the bioreactor as compared to the raw livestock waste, which could be due to a nitrification reaction.

The phosphorus (mineral and total) concentration in the preparation reservoir and at the output of the bioreactor was lower than in the raw livestock waste. This can indicate that phosphorus started to sediment in the preparation reservoir and in the bioreactor. In the settling reservoir, the total and mineral phosphorus concentration was significantly higher at the bottom than at the surface, which confirms the phosphorus separation efficiency following the treatment.

According to the data that were gathered, the total dissolved organic carbon was lower in the preparation reservoir and in the bioreactor compared to the raw livestock waste. The reduction in the total dissolved organic carbon correlated with a reduction in the biochemical oxygen demand at day 5 (BOD5) under controlled conditions (BOD5), which is an indirect measure of the sum of biodegradable organic substances in the sample that was analyzed. These results indicate that removal of organic matter was occurring during the treatment.

The Escherichia coli (E. coli) and fecal coliforms counts were significantly lower at the output of the bioreactor as compared to the raw livestock waste. The data that were gathered indicate a reduction of 99.9% of E. coli and a reduction of 98.5% of total coliforms. It can be concluded that the bioreaction treatment contributes to hygienization of the livestock waste.

1. A process for treating a livestock waste, comprising:
subjecting the livestock waste to a preparation treatment, comprising:
supplying the livestock waste to a preparation reservoir in fluid communication with a first oxygen-containing gas distribution system; and
aerating the livestock waste with a first oxygen-containing gas from the first oxygen-containing gas distribution system to produce a stabilized livestock waste; and
subjecting the stabilized livestock waste to a bioreaction treatment, comprising:
supplying the stabilized livestock waste to a bioreactor in fluid communication with the preparation reservoir and with a second oxygen-containing gas distribution system, the bioreactor comprising a pipeline configured for receiving and circulating the stabilized livestock waste therewithin; and
aerating the stabilized livestock waste with a second oxygen-containing gas from the second oxygen-containing gas distribution system to enable aerobic reactions to occur within the stabilized livestock waste and produce an aerated livestock product having a solid component and a liquid component, the second oxygen-containing gas distribution system comprising a conduit extending within the pipeline and comprising a plurality of openings to introduce the second oxygen-containing gas within the pipeline.

2. The process of claim 1, wherein the pipeline comprises at least one portion that extends substantially longitudinally.

3. The process of claim 1, wherein the pipeline comprises a plurality of pipelines.

4. The process of claim 3, wherein at least two pipelines of the plurality of pipelines are provided in a superposed relationship relative to each other.

5. The process of claim 3, wherein at least two pipelines of the plurality of pipelines is provided in a side-by-side relationship relative to each other.

6. The process of any one of claims 3 to 5, wherein the plurality of pipelines forms a network of interconnected pipelines in fluid communication with one another.

7. The process of any one of claims 3 to 6, wherein at least one of the plurality of pipelines comprises a portion that extends substantially longitudinally.

8. The process of any one of claims 1 to 7, wherein the aerated livestock product is suitable for use as a fertilizer.

9. The process of any one of claims 1 to 8, further comprising subjecting the aerated livestock product to a solid-liquid separation to obtain a solid-enriched phase comprising predominantly the solid component and a solid-depleted phase comprising predominantly the liquid component.

10. The process of claim 9, wherein subjecting the aerated livestock product to the solid-liquid separation comprises settling the aerated livestock in a settling reservoir.

11. The process of claim 10, further comprising retrieving a portion of the solid-enriched phase from the settling reservoir to obtain a solid-enriched stream.

12. The process of claim 10, further comprising retrieving a portion of the solid-depleted phase from the settling reservoir to obtain a solid-depleted stream.

13. The process of claim 9, wherein subjecting the aerated livestock product to the solid-liquid separation comprises supplying the aerated livestock product to at least one of a decanter, a gravity settler, and a thickener.

14. The process of claim 9, wherein subjecting the aerated livestock product to the solid-liquid separation comprises supplying the aerated livestock product to a decanter centrifuge.

15. The process of any one of claims 9 to 14, wherein the solid-enriched phase is usable as a substantially solid fertilizer comprising phosphorus.

16. The process of any one of claims 9 to 14, wherein the solid-enriched phase is subjected to a further treatment to obtain a substantially solid fertilizer.

17. The process of any one of claims 9 to 14, wherein the solid-depleted phase is usable as a substantially liquid fertilizer comprising nitrogen.

18. The process of any one of claims 9 to 14, wherein the solid-depleted phase is subjected to a further treatment to obtain a substantially liquid fertilizer.

19. The process of any one of claims 1 to 18, wherein the preparation treatment further comprises mixing the livestock waste at least during the aerating of the livestock waste.

20. The process of any one of claims 1 to 19, wherein the preparation treatment further comprises mixing the livestock waste prior the aerating of the livestock waste.

21. The process of claim 19 or 20, wherein mixing the livestock waste comprises homogenizing the livestock waste.

22. The process of any one of claims 1 to 21, wherein the preparation treatment further comprises recirculating the livestock waste via a recirculation loop.

23. The process of claim 22, wherein recirculating the livestock waste comprises controlling a recirculation flow rate of the livestock waste via the recirculation loop.

24. The process of any one of claims 1 to 23, wherein aerating the livestock waste comprises passing the livestock waste through a Venturi device.

25. The process of any one of claims 1 to 24, wherein aerating the livestock waste is performed to avoid coalescence of bubbles of the first oxygen-containing gas.

26. The process of any one of claims 1 to 25, wherein aerating the stabilized livestock waste comprises producing fine bubbles within the stabilized livestock waste.

27. The process of any one of claims 1 to 26, wherein aerating the stabilized livestock waste is performed to reduce an organic matter content thereof.

28. The process of any one of claims 1 to 27, further comprising controlling an operating parameter of the preparation treatment to achieve a given property of the stabilized livestock waste.

29. The process of claim 28, wherein the operating parameter comprises at least one of a temperature of the livestock waste within the preparation reservoir, a residence time of the livestock waste within the preparation reservoir, and a flow rate of the first oxygen-containing gas.

30. The process of claim 29, wherein the temperature of the livestock waste during the preparation treatment is between 5° C. and 45° C.

31. The process of claim 29, wherein the temperature of the livestock waste during the preparation treatment is between 15° C. and 45° C.

32. The process of claim 29, wherein the temperature of the livestock waste during the preparation treatment is above 45° C.

33. The process of any one of claims 29 to 32, wherein the residence time of the livestock waste in the preparation reservoir is at least 10 days.

34. The process of any one of claims 29 to 32, wherein the residence time of the livestock waste in the preparation reservoir is between 4 days and 30 days.

35. The process of any one of claims 29 to 34, wherein the flow rate of the first oxygen-containing gas during the preparation treatment is between 5 L O₂/min·m³ and 40 L O₂/min·m³.

36. The process of any one of claims 29 to 35, wherein the flow rate of the first oxygen-containing gas during the preparation treatment is between 5 L O₂/min·m³ and 25 L O₂/min·m³.

37. The process of any one of claims 29 to 35, wherein the flow rate of the first oxygen-containing gas during the preparation treatment is between 0.2 L O₂/min·m³ and 2 L O₂/min·m³.

38. The process of any one of claims 28 to 37, wherein the given property of the stabilized livestock waste comprises at least one of dissolved organic carbon (DOC), Total solids, Total suspended solids (TSS), Total dissolved solids (TDS), Total volatile solids (TVS), Volatile suspended solids (VSS), a biochemical oxygen demand (BOD), a chemical oxygen demand (COD), a pH of the livestock waste a composition of the livestock waste, and a concentration of oxygen in the stabilized livestock waste.

39. The process of claim 38, wherein the dissolved organic carbon of the stabilized livestock waste is between 20 000 mg/kg and 5 000 mg/kg.

40. The process of claim 38, wherein the dissolved organic carbon of the stabilized livestock waste is between 15 000 mg/kg and 3 000 mg/kg.

41. The process of any one of claims 38 to 40, wherein the total solids of the stabilized livestock is between 65 g/L and 160 g/L.

42. The process of any one of claims 38 to 41, wherein the total suspended solids of the stabilized livestock are between 55 g/L and 130 g/L.

43. The process of any one of claims 38 to 41, wherein the total dissolved solids of the stabilized livestock are between 12 g/L and 25 g/L.

44. The process of any one of claims 38 to 43, wherein the total volatile solids of the stabilized livestock are between 90 g/L and 130 g/L.

45. The process of any one of claims 38 to 44, wherein the volatile suspended solids of the stabilized livestock are between 3 g/L and 120 g/L.

46. The process of any one of claims 38 to 45, wherein the pH of the livestock waste is between 5 and 9.

47. The process of any one of claims 38 to 45, wherein the pH of the livestock waste is between 6 and 8.

48. The process of any one of claims 38 to 45, wherein the pH of the livestock waste is between 7 and 8.5.

49. The process of any one of claims 38 to 48, wherein the concentration of oxygen in the stabilized livestock waste is below 1%.

50. The process of any one of claims 38 to 48, wherein the concentration of oxygen in the stabilized livestock waste is between 1% and 15%.

51. The process of any one of claims 38 to 48, wherein the concentration of oxygen in the stabilized livestock waste is above 15%.

52. The process of any one of claims 1 to 51, wherein the solid-enriched phase of the aerated livestock product represents approximately 50% v/v of the aerated livestock product.

53. The process of any one of claims 1 to 51, wherein the solid-enriched phase of the aerated livestock product represents approximately 30% v/v of the aerated livestock product, and the solid-depleted phase represents approximately 70% v/v of the aerated livestock product.

54. The process of any one of claims 1 to 53, wherein at least one of the first oxygen-containing gas and the second oxygen-containing gas comprises air.

55. A process for treating a livestock waste comprising solids and liquid, the process comprising:
subjecting the stabilized livestock waste to a bioreaction treatment, comprising:
supplying the stabilized livestock waste to a bioreactor comprising a pipeline configured for receiving and circulating the stabilized livestock waste therewithin, the bioreactor being in fluid communication with an oxygen-containing gas distribution system configured for introducing an oxygen-containing gas into the stabilized livestock waste; and
aerating the stabilized livestock waste with the oxygen-containing gas from the oxygen-containing gas distribution system to enable aerobic reactions to occur within the stabilized livestock waste and produce an aerated livestock product having a solid component and a liquid component, the oxygen-containing gas distribution system extending within the pipeline and comprising a plurality of openings to introduce the oxygen-containing gas within the pipeline.

56. The process of claim 55, wherein the pipeline comprises at least one portion that extends substantially longitudinally.

57. The process of claim 55, wherein the pipeline comprises a plurality of pipelines.

58. The process of claim 57, wherein at least two pipelines of the plurality of pipelines are provided in a superposed relationship relative to each other.

59. The process of claim 57, wherein at least two pipelines of the plurality of pipelines is provided in a side-by-side relationship relative to each other.

60. The process of any one of claims 57 to 59, wherein the plurality of pipelines forms a network of interconnected pipelines in fluid communication with one another.

61. The process of any one of claims 57 to 60, wherein at least one of the plurality of pipelines comprises a portion that extends substantially longitudinally.

62. The process of any one of claims 55 to 61, wherein the aerated livestock product is suitable for use as a fertilizer.

63. The process of any one of claims 55 to 62, further comprising subjecting the aerated livestock product to a solid-liquid separation to obtain a solid-enriched phase comprising predominantly the solid component and a solid-depleted phase comprising predominantly the liquid component.

64. The process of claim 63, wherein subjecting the aerated livestock product to the solid-liquid separation comprises settling the aerated livestock in a settling reservoir.

65. The process of claim 64, further comprising retrieving a portion of the solid-enriched phase from the settling reservoir to obtain a solid-enriched stream.

66. The process of claim 64 or 65, further comprising retrieving a portion of the solid-depleted phase from the settling reservoir to obtain a solid-depleted stream.

67. The process of any one of claims 63 to 66, wherein subjecting the aerated livestock product to the solid-liquid separation comprises supplying the aerated livestock product to at least one of a decanter, a gravity settler, and a thickener.

68. The process of any one of claims 63 to 66, wherein subjecting the aerated livestock product to the solid-liquid separation comprises supplying the aerated livestock product to a decanter centrifuge.

69. The process of any one of claims 63 to 68, wherein the solid-enriched phase is usable as a solid fertilizer comprising phosphorus.

70. The process of any one of claims 63 to 69, wherein the solid-depleted phase is usable as a liquid fertilizer comprising nitrogen.

71. The process of any one of claims 55 to 70, wherein the aerating is performed intermittently.

72. The process of any one of claims 55 to 70, wherein the aerating is performed continuously.

73. The process of any one of claims 55 to 72, further comprising one or more features as defined in any one of claims 1 to 54.

74. A system for treating a livestock waste, comprising:
a preparation unit comprising:
a preparation reservoir configured to receive the livestock waste; and
a first oxygen-containing gas distribution system in fluid communication with the preparation reservoir to supply a first oxygen-containing gas to the livestock waste and produce a stabilized livestock waste;
a bioreactor unit comprising:
a bioreactor in fluid communication with the preparation reservoir, the bioreactor comprising:
a pipeline configured for receiving and circulating the stabilized livestock waste therewithin from one location to another; and
a second oxygen-containing gas distribution system in fluid communication with the pipeline to supply a second oxygen-containing gas to the stabilized livestock and produce an aerated livestock product having a solid component and a liquid component, the second oxygen-containing gas distribution system comprising a conduit extending within the pipeline and comprising a plurality of openings to introduce the second oxygen-containing gas within the pipeline and into the stabilized livestock waste.

75. The system of claim 74, further comprising a solid-separation unit configured to receive the aerated livestock product to produce a solid-enriched phase comprising the solid component and a solid-depleted phase comprising the liquid component.

76. The system of claim 74 or 75, wherein the pipeline comprises at least one portion that extends substantially longitudinally.

77. The system of claim 74 or 75, wherein the pipeline comprises a plurality of pipelines.

78. The system of claim 77, wherein at least two pipelines of the plurality of pipelines are provided in a superposed relationship relative to each other.

79. The system of claim 77, wherein at least two pipelines of the plurality of pipelines is provided in a side-by-side relationship relative to each other.

80. The system of any one of claims 77 to 79, wherein the plurality of pipelines forms a network of interconnected pipelines in fluid communication with one another.

81. The system of any one of claims 77 to 80, wherein at least one of the plurality of pipelines comprises a portion that extends substantially longitudinally.

82. The system of any one of claims 77 to 81, wherein the bioreactor includes a main pipeline that divides into the plurality of pipelines.

83. The system of any one of claims 77 to 82, wherein the bioreactor includes a number of pipelines determined according to their respective length to achieve a resulting length of the bioreactor.

84. The system of any one of claims 77 to 83, wherein a configuration of the pipeline is determined in accordance with variations in a ground surface between the preparation reservoir and the solid-liquid separation unit.

85. The system of any one of claims 74 to 84, wherein the first oxygen-containing gas distribution system is configured to avoid coalescence of bubbles of the first oxygen-containing gas.

86. The system of any one of claims 74 to 85, wherein the first oxygen-containing gas distribution system is configured to provide fine bubbles into the stabilized livestock waste.

87. The system of any one of claims 74 to 86, wherein the first oxygen-containing gas comprises air.

88. The system of any one of claims 74 to 87, wherein the second oxygen-containing gas comprises air.

89. The system of any one of claims 74 to 88, wherein the bioreactor comprises a series of bioreactors provided in series.

90. The system of any one of claims 74 to 89, wherein the pipeline has a diameter of between 70 cm and 120 cm.

91. The system of any one of claims 74 to 90, wherein a length and/or a diameter of the pipeline is determined according to a volume of stabilized livestock waste to be treated.

92. The system of any one of claims 74 to 91, wherein the bioreactor is configured to providing a turbulent flow of the livestock waste circulating in the pipeline to enhance mixing of the livestock waste.

93. The system of any one of claims 74 to 92, wherein the conduit has a diameter of between 1 cm and 10 cm.

94. The system of any one of claims 74 to 92, wherein the conduit has a diameter between 0.1 cm and 3 cm.

95. The system of any one of claims 74 to 94, wherein the conduit comprises a plurality of conduits.

96. The system of any one of claims 74 to 95, wherein the plurality of openings includes a first series of openings having a first diameter in a first section of the bioreactor that is closer to the preparation reservoir, and a second series of openings having a second diameter in a second section of the bioreactor that is closer to the solid-liquid separation unit.

97. The system of any one of claims 74 to 96, wherein the plurality of openings includes a first series of openings provided at a first distance from one another in a first section of the bioreactor that is closer to the preparation reservoir, and a second series of openings provided at a second distance from one another in a second section of the bioreactor that is closer to the solid-liquid separation unit.

98. The system of any one of claims 74 to 97, wherein the plurality of openings comprises openings provided as an array extending longitudinally along a length of the conduit.

99. The system of any one of claims 74 to 97, wherein the plurality of openings comprises openings distributed randomly around an outer periphery of the conduit.

100. The system of any one of claims 74 to 97, wherein the plurality of openings comprises openings distributed according to a given pattern around an outer periphery of the conduit.

101. The system of any one of claims 74 to 100, wherein the second oxygen-containing gas distribution system is configured for introducing the second oxygen-containing gas into the stabilized livestock waste at a flow rate between 5 L O₂/min·m³ and 60 L O₂/min·m³.

102. The system of any one of claims 74 to 100, wherein the second oxygen-containing gas distribution system is configured for introducing the second oxygen-containing gas into the stabilized livestock waste at a flow rate between 10 L O₂/min·m³ and 50 L O₂/min·m³.

103. The system of any one of claims 74 to 100, wherein the second oxygen-containing gas distribution system is configured for introducing the second oxygen-containing gas into the stabilized livestock waste at a flow rate to achieve a given concentration of oxygen in the aerated livestock product.
